(19) United States
(12) Patent Application Publication
(10) Pub. No.: US 2026/0211594 A1
(43) Pub. Date: Jul. 23, 2026

(54) INFORMATION PROCESSING APPARATUS, INFORMATION PROCESSING SYSTEM, CONTROL METHOD FOR INFORMATION PROCESSING APPARATUS, AND STORAGE MEDIUM

(71) Applicant: CANON KABUSHIKI KAISHA, Tokyo (JP)

(72) Inventor: So Miyamoto, Kanagawa (JP)

(21) Appl. No.: 19/442,168

(22) Filed: Jan. 7, 2026

(30) Foreign Application Priority Data
Jan. 21, 2025 (JP) 2025-008576

(51) Int. Cl. G06F 3/12; G06F 8/61

(52) U.S. Cl. CPC G06F 3/1225; G06F 3/1204; G06F 3/1287; G06F 8/61

(57) ABSTRACT

An information processing apparatus receives an installer package of the application, which is transmitted from a cloud printing server; controls receiving of information about an image forming apparatus from the cloud printing server, the image forming apparatus being registered in a tenant to which a user belongs, being usable by the user, and being capable of communicating with the cloud printing server; causes the application, which is installed using the installer package, to display a screen for selecting a driver corresponding to the image forming apparatus usable by the user, for which the information was received; transmits an obtainment request for the driver selected in the screen to the cloud printing server; and controls receiving of, from the cloud printing server, the driver for which the obtainment request was made.

### BACKGROUND

### Field of the Technology

The present disclosure relates to an information processing apparatus, an information processing system, a control method for an information processing apparatus, and a storage medium.

### Description of the Related Art

With the recent spread of cloud printing platforms, cloud printing systems in which a printing service provided in the cloud and an image forming apparatus such as a printer or a digital multifunction peripheral installed in a company operate in conjunction with each other are becoming increasingly common. One advantage of adopting such a cloud printing system is the reduction of complex tasks involved in installation by eliminating the need to connect the image forming apparatus to a company intranet, for example. Meanwhile, some printing services have a use mode in which one or more devices are collectively managed in the cloud at the company level or in an organizational unit that is a part thereof. This unit of management is commonly called a “tenant”.

Thus far, in such a cloud printing platform, print jobs can be sent from a terminal apparatus to the cloud by using a client app connected to a cloud service in conjunction with a printer driver. Such a printer driver can be used for printing with many models, but a general-purpose driver having a limited range of available print settings is typically used.

Meanwhile, a package including a client app and a driver installer (also called an “installer package”) is stored in cloud storage. Such a package is generally obtained and installed in a terminal apparatus to set up the terminal apparatus in the cloud printing platform. Japanese Patent Laid-Open No. 2013-20354 describes batch installation processing for one or more pieces of software using an installer package.

It is conceivable to provide a model-specific driver for print settings or models not supported by a general-purpose driver. However, including drivers for all models that are available when the installer package is created will increase the size of the package. This results in an increased amount of cloud resources being used. The package will also take longer to download, which is inefficient.

In the technique described in Japanese Patent Laid-Open No. 2013-20354, when the terminal apparatus obtains a driver from cloud storage, only a driver selected by the user is dynamically packaged as an installer package and downloaded. This makes it possible to download the driver of an image forming apparatus that prints using print settings not supported by a general-purpose driver. This also reduces the size of the package, which makes it possible to shorten the time required to download the package.

However, the method described in Japanese Patent Laid-Open No. 2013-20354 dynamically generates the package before the installer package is downloaded, which indicates it takes time to generate the package. Furthermore, the downloaded installer package is not compatible with models added to the tenant after the package is downloaded, which indicates the installer package must be obtained again.

### SUMMARY

The present disclosure enables the realization of a novel technique that makes it possible to efficiently deploy a printer driver for each of multiple users in a cloud printing system.

One aspect of the present disclosure provides an information processing apparatus capable of communicating with a cloud printing server that provides a cloud printing service, the information processing apparatus comprising: one or more memory devices that store a set of instructions; and one or more processors that execute the set of instructions to: control communication with the cloud printing server and an application for using the cloud printing service, wherein the one or more processors execute instructions in the one or more memory devices to: receive an installer package of the application, which is transmitted from the cloud printing server; control receiving of information about an image forming apparatus from the cloud printing server, the image forming apparatus being registered in a tenant to which a user belongs, being usable by the user, and being capable of communicating with the cloud printing server; cause the application, which is installed using the installer package, to display a screen for selecting a driver corresponding to the image forming apparatus usable by the user, for which the information was received; transmit an obtainment request for the driver selected in the screen to the cloud printing server; and control receiving of, from the cloud printing server, the driver for which the obtainment request was made.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an image forming system according to one embodiment.

FIG. 2A is a diagram illustrating the hardware configuration of an image forming apparatus according to one embodiment.

FIG. 2B is a diagram illustrating the hardware configuration of a cloud printing service according to one embodiment.

FIG. 2C is a diagram illustrating the hardware configuration of an information processing terminal according to one embodiment.

FIG. 3 is a diagram illustrating the software configuration of an image forming apparatus according to one embodiment.

FIG. 4 is a diagram illustrating the software configuration of a cloud printing service according to one embodiment.

FIG. 5 is a diagram illustrating the software configuration of an information processing terminal according to one embodiment.

FIG. 6 is a flowchart illustrating a processing sequence according to one embodiment.

FIG. 7 is a diagram illustrating a display screen according to one embodiment.

FIG. 8A is a diagram illustrating information of an image forming apparatus according to one embodiment.

FIG. 8B is a diagram illustrating information of an image forming apparatus according to one embodiment.

FIG. 8C is a diagram illustrating information of an image forming apparatus according to one embodiment.

FIG. 9 is a flowchart illustrating a processing sequence according to one embodiment.

FIG. 10 is a diagram illustrating a display screen according to one embodiment.

FIG. 11A is a diagram illustrating a display screen according to one embodiment.

FIG. 11B is a diagram illustrating a display screen according to one embodiment.

FIG. 11C is a diagram illustrating a display screen according to one embodiment.

FIG. 11D is a diagram illustrating a display screen according to one embodiment.

FIG. 12A is a diagram illustrating a display screen according to one embodiment.

FIG. 12B is a diagram illustrating a display screen according to one embodiment.

FIG. 13 is a flowchart illustrating a processing sequence according to one embodiment.

FIG. 14 is a flowchart illustrating a processing sequence according to one embodiment.

FIG. 15A is a diagram illustrating a display screen according to one embodiment.

FIG. 15B is a diagram illustrating a display screen according to one embodiment.

FIG. 16 is a diagram illustrating a display screen according to one embodiment.

FIG. 17 is a diagram illustrating a display screen according to one embodiment.

FIG. 18 is a flowchart illustrating a processing sequence according to one embodiment.

FIG. 19 is a flowchart illustrating a processing sequence according to one embodiment.

FIG. 20 is a diagram illustrating a display screen according to one embodiment.

FIG. 21 is a flowchart illustrating a processing sequence according to one embodiment.

FIG. 22 is a flowchart illustrating a processing sequence according to one embodiment.

FIG. 23 is a flowchart illustrating a processing sequence according to one embodiment.

FIG. 24 is a flowchart illustrating a processing sequence according to one embodiment.

FIG. 25 is a flowchart illustrating a processing sequence according to one embodiment.

FIG. 26 is a flowchart illustrating a processing sequence according to one embodiment.

FIG. 27 is a flowchart illustrating a processing sequence according to one embodiment.

FIG. 28 is a flowchart illustrating a processing sequence according to one embodiment.

FIG. 29 is a flowchart illustrating a processing sequence according to one embodiment.

FIG. 30 is a flowchart illustrating a processing sequence according to one embodiment.

FIG. 31 is a diagram illustrating a display screen according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Herein, the term “image forming apparatus” is assumed to refer broadly to any apparatus that forms (records) an image on a recording material (a recording medium), including single-function printers, copiers, multifunction peripherals, commercial printers, and the like. Note also that the term “print” as used herein may also be referred to as “forming an image”. Hereinafter, the “image forming apparatus” may also be referred to as a “printer” or a “device”.

### System Configuration

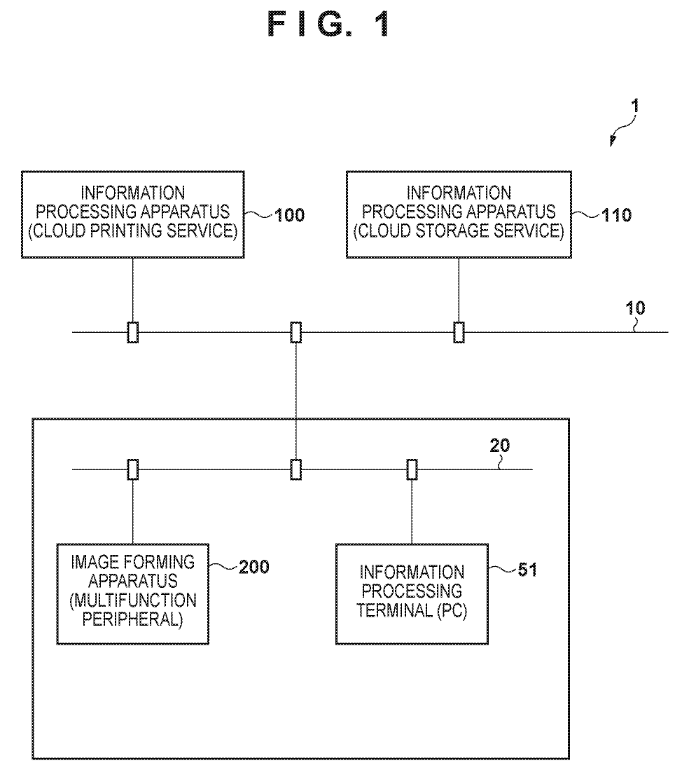

The configuration of an image forming system 1 (an example of an “information processing system”) according to the present embodiment will be described first with reference to FIG. 1. The image forming system 1 is configured including, for example, an information processing apparatus 100, an information processing apparatus 110, an information processing terminal 51, and an image forming apparatus 200, and these are connected over a network 10 or 20. Here, in the image forming system 1, an administrator may manage a single image forming apparatus 200 or a plurality of image forming apparatuses 200 collectively through the information processing apparatus 100 in, for example, a company or an organizational unit belonging to a company. In such a case, this unit of management is also referred to as a “tenant”. The information processing terminal 51 is an example of an “information processing apparatus capable of communicating with a cloud printing server that provides a cloud printing service”. The information processing apparatus 100 is an example of a “cloud printing server”.

The information processing apparatus 100 is a server hosted on a cloud platform, and provides a web portal to connected clients. The information processing apparatus 100 in particular provides services related to printing. Hereinafter, the information processing apparatus 100 may also be referred to as a “cloud printing service 100”. The cloud printing service 100 is an example of a “cloud printing server that provides a cloud printing service”. The information processing apparatus 110 provides a general-purpose cloud storage service, such as Google Drive (registered trademark), for example. The information processing apparatus 110 may be referred to as a “cloud storage service 110” hereinafter.

The image forming apparatus 200 is a digital multifunction peripheral provided with a plurality of functions, such as a copy function, a scan function, a print function, a fax function, an email transmission function, and the like, for example. The apparatus may instead be a printer provided with a single function. Although only one image forming apparatus 200 is illustrated in FIG. 1, the number of image forming apparatuses 200 is not limited to one.

The information processing terminal 51 is, for example, a personal computer (PC), but may be an information processing terminal such as a smartphone, a tablet, or the like. A local network 20 is, for example, a network within a company office, and FIG. 1 illustrates an example in which a plurality of image forming apparatuses and information processing terminals used by a plurality of employees are connected within the company office.

The image forming apparatus 200 and the information processing terminal 51 are capable of communicating with the cloud printing service 100 over the network 10, and are capable of using a web portal, a printing service, and the like provided by the cloud printing service 100. Likewise, each image forming apparatus 200 is capable of communicating with the cloud storage service 110 over the network 10, and is capable of using a file service provided by the cloud storage service 110.

### Hardware Configuration of Image Forming Apparatus 200

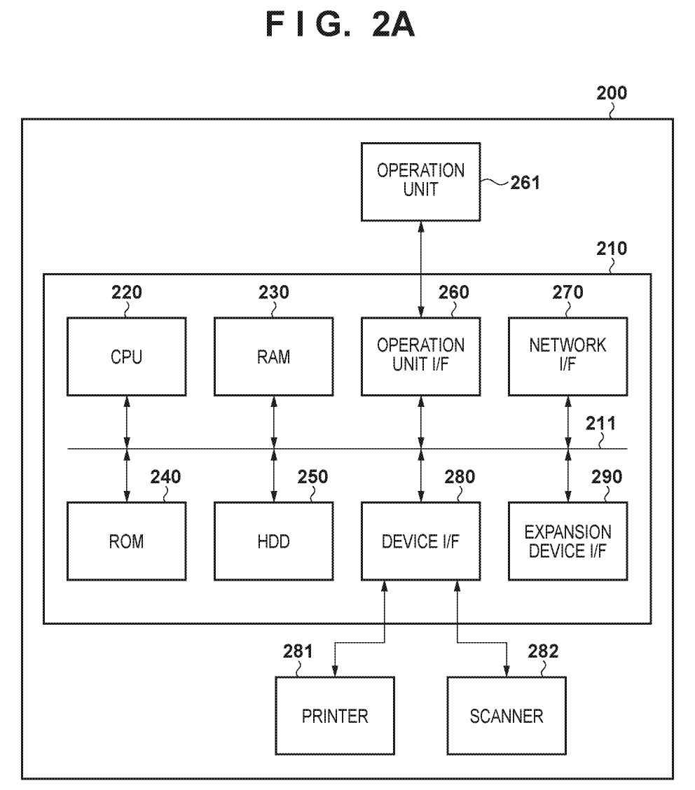

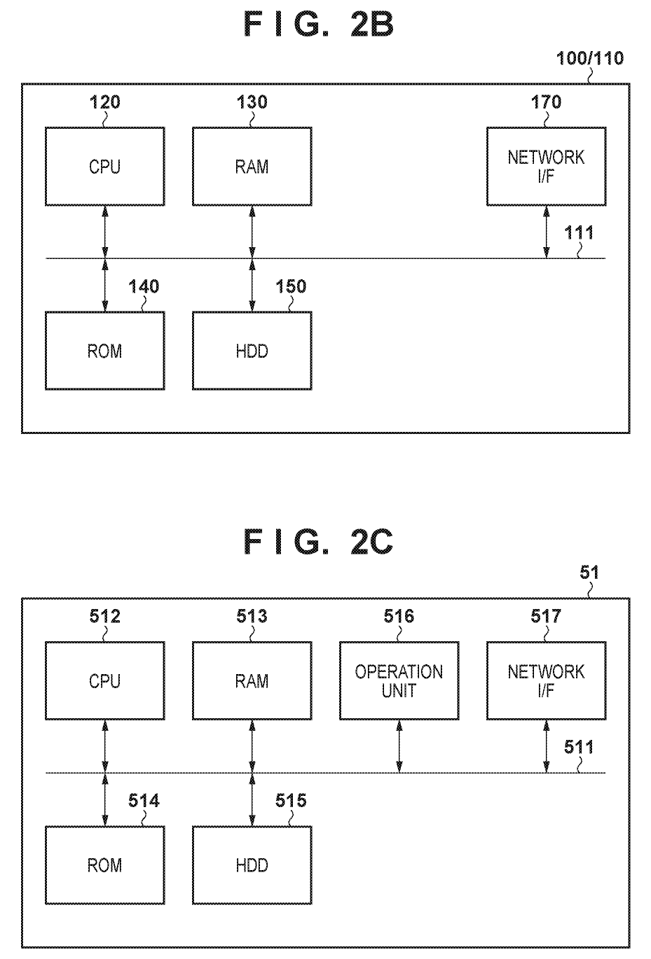

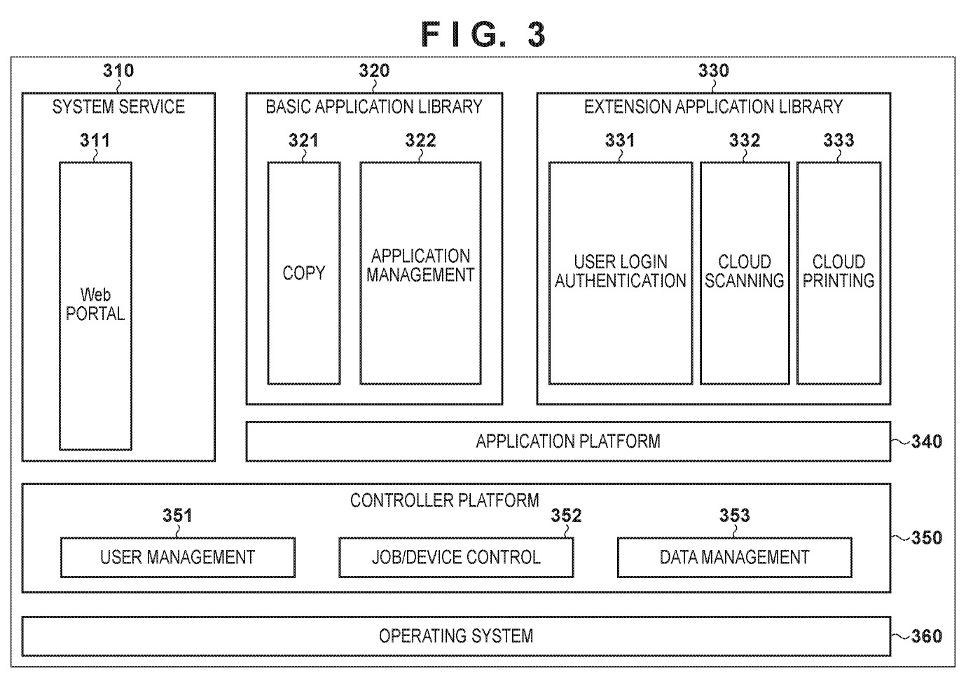

The hardware configuration of the image forming apparatus 200 will be described next with reference to FIG. 2A. The image forming apparatus 200 is a digital multifunction peripheral, for example, and is configured including a controller unit 210, an operation unit 261, a printer 281, and a scanner 282. The controller unit 210 includes a CPU 220, a RAM 230, a ROM 240, an HDD 250, an operation unit I/F 260, a network I/F 270, a device I/F 280, and an expansion device I/F 290.

The CPU 220 is a unit that executes control programs provided in the image forming apparatus 200, and controls the operations of devices connected to the controller unit through the I/Fs and storage medium memory. Programs such as operating systems, system software, application software, and the like, as well as data, are stored in the RAM 230. A system boot program, system programs, application programs, and the like are stored in the ROM 240. Furthermore, information necessary for the image forming apparatus 200, such as fonts and the like, may be stored as well. The HDD 250 is a storage device having a larger capacity than the RAM 230, and stores an operating system, system software, application software, image data, setting data, print jobs, user information, and the like. Programs stored in the HDD 250 are loaded into the RAM 230 by the CPU 220 executing programs stored in the ROM 240. The CPU 220 then executes programs loaded into the RAM 230, and processes data stored in the RAM 230, the ROM 240, and the HDD 250. Some compact multifunction peripherals are configured without the HDD 250, and system software, application software, and the like are stored in the ROM 240 instead. Alternatively, the configuration may be such that a storage device other than a hard disk, such as Flash memory constituting a solid-state disk (SSD), is used instead of the HDD 250.

The operation unit I/F 260 is an interface unit that controls input/output with the operation unit 261, which includes a touch panel, for example, and outputs image data to be displayed in the operation unit 261 to the operation unit 261. The operation unit I/F 260 also communicates, to the CPU 220, input information resulting from a user operating the operation unit 261. The network I/F 270 is configured including a communication module, connects to a network, and communicates with external devices on the network.

The device I/F 280 connects the printer 281, the scanner 282, and this like, which are image input and output devices, to the controller unit 210, and inputs and outputs image data. The CPU 220 reads a document image by controlling the scanner 282, and the read image data is stored in the RAM 230, the HDD 250, or the like through the device I/F 280. The stored image data is subjected to image processing by application programs loaded into the RAM 230 as necessary. The CPU 220 also prints the image data onto a sheet by outputting the image data to the printer 281 through the device I/F 280 and controlling the printer 281.

The expansion device I/F 290 is configured including a USB port, a wireless transceiver such as Bluetooth, or the like to enable any optional devices to be connected. The expansion device I/F 290 enables optional devices, such as an ID card reader, a biometric authentication device, or the like, to be connected to the image forming apparatus 200.

Note that the image forming apparatus 200 is not limited to the configuration illustrated in FIG. 2A. For example, the image forming apparatus 200 may be a printer that does not include the scanner 282. If the image forming apparatus 200 is a multifunction peripheral having a fax function, an I/F for a modem apparatus (not shown in FIG. 2A) may be provided in the controller unit 210, and the image forming apparatus 200 may be connected to a public line by the modem to transmit faxes.

### Hardware Configuration of Cloud Print Service 100

The hardware configuration of the cloud printing service 100 will be described next with reference to FIG. 2B. The cloud printing service 100 is configured including a CPU 120, a RAM 130, a ROM 140, an HDD 150, and a network I/F 170, which are connected to each other over a bus 111. The CPU 120 controls the overall operations by reading out control programs stored in the ROM 140 and executing various types of processing. The RAM 130 is used as the main memory of the CPU 120, a temporary storage region such as a work area, or the like. The HDD 150 is a high-capacity storage unit that stores image data, various types of programs, and the like. The network I/F 170 is configured including a communication module, and is an interface for connecting to the Internet. The hardware configuration of the cloud storage service 110 corresponds to the hardware configuration of the cloud printing service 100 illustrated in FIG. 2B, for example, and is therefore not illustrated here.

### Hardware Configuration of Information Processing Terminal 51

The hardware configuration of the information processing terminal 51 will be described next with reference to FIG. 2C. The information processing terminal 51 is configured including a CPU 512, a RAM 513, a ROM 514, an HDD 515, an operation unit 516, and a network I/F 517, which are connected to each other over a bus 511. The CPU 512 controls the overall operations by reading out control programs stored in the ROM 514 and executing various types of processing. Note that the CPU 512 is an example of a “control unit”. The RAM 513 is used as the main memory of the CPU 512, a temporary storage region such as a work area, or the like. The HDD 515 is a high-capacity storage unit that stores image data, various types of programs, and the like. The operation unit 516 is configured including an input device such as a keyboard and a mouse, and an output device such as a display. The operation unit 516 is an interface for inputting various operation signals to the information processing terminal 51 and displaying results of processing by the information processing terminal 51. The network I/F 517 is an interface for connecting to the Internet, and is configured including a communication module.

### Software Configuration of Image Forming Apparatus 200

The software configuration of programs executed by the CPU 220 of the image forming apparatus 200 will be described next with reference to FIG. 3. An operating system 360 provides various resource management services and frameworks optimized for controlling embedded systems for software running thereon. Specifically, the various resource management services and frameworks include multi-task management for running multiple processes substantially in parallel by managing multiple execution contexts for processing by the CPU 220, and inter-task communication for implementing synchronization and data exchange between tasks. Furthermore, the operating system 360 provides memory management, interrupt management, various device drivers, and local interfaces, as well as a protocol stack that implements processing through various protocols such as network and communication protocols, and the like, for example.

A controller platform 350 is configured including user management 351, a job/device control module 352, and a data management module 353. The user management 351 provides applications with a mechanism for managing local users, and credentials thereof, in the image forming apparatus 200 using the RAM 230 or the HDD 250. A login application implements user login control for the image forming apparatus 200 using the local user credentials managed by the user management 351. The job/device control module 352 executes image forming jobs such as scanning, printing, and copying while controlling the printer 281 and the scanner 282 in accordance with instructions from applications. The states of devices such as the printer 281 and the scanner 282, errors in those devices, and the like are managed as well.

The data management module 353 manages image data and various types of setting data required when executing an image forming job. The data management module 353 also manages a job execution history, counter information, various types of data controlled by other applications, and configuration information and capability information of the image forming apparatus 200.

A system service 310 is a software module responsible for managing the controller platform 350 and operating system program updates, as well as device information/network settings and the like. Furthermore, the system service 310 is configured including a web portal 311, and can be operated from a remote terminal such as the information processing terminal 51.

An application platform 340 is middleware that can be used from various types of applications. Specifically, the operating system 360 and the mechanism of the controller platform 350 are configured to be usable from various types of applications in a basic application library 320 and an extension application library 330 (described later).

The basic application library 320 is a group of applications that provide the basic functions of the image forming apparatus 200, which are stored in the ROM 240 or the HDD 250 in an initial state at the time of purchase of the image forming apparatus 200. The extension application library 330 is any group of applications that are individually installed and run in order to extend the functions implemented by the image forming apparatus 200. Each application displays a screen in the operation unit 261, and implements various types of functions in response to user operations accepted by the operation unit 261.

FIG. 3 illustrates an example in which copying 321 and application management 322 are included in the basic application library 320. Copying 321 is an application for executing a copy job of scanning a document and printing onto a sheet. Application management 322 is an application for managing the installation and uninstallation of extension applications in the extension application library 330.

FIG. 3 illustrates, as an example, a state in which extension applications of user login authentication 331, cloud scanning 332, and cloud printing 333 are installed as the extension application library 330. User login authentication 331 is an application that displays a screen for entering user credentials in the operation unit 261 and implements user login processing for the image forming apparatus 200 using the user credentials entered from the operation unit 261. The user login processing is implemented not only using the user credentials entered through the operation unit 261, but also using user credentials read through an ID card reader or a biometric authentication device connected through the expansion device I/F. User login authentication 331 communicates with the cloud printing service 100 over the network I/F 270. User login authentication 331 then authenticates the user by verifying user credentials managed in the cloud printing service 100 against the user credentials entered in the image forming apparatus 200. User login authentication 331 may also authenticate the user by verifying the user credentials against user credentials managed by user management 351.

Cloud scanning 332 is an application that communicates with an unspecified cloud storage service 110 and transmits, to the cloud storage service 110, an image file read by executing a scanning job in the image forming apparatus 200. Cloud printing 333 is an application that communicates with the cloud printing service 100, obtains image data to be printed from the cloud printing service 100, and executes a print job in the image forming apparatus 200. Cloud printing 333 is an application that obtains file data to be printed from the cloud storage service 110 and executes a print job in the image forming apparatus. Cloud printing 333 also transmits a result of executing the print job to the cloud printing service 100.

### Software Configuration of Cloud Server

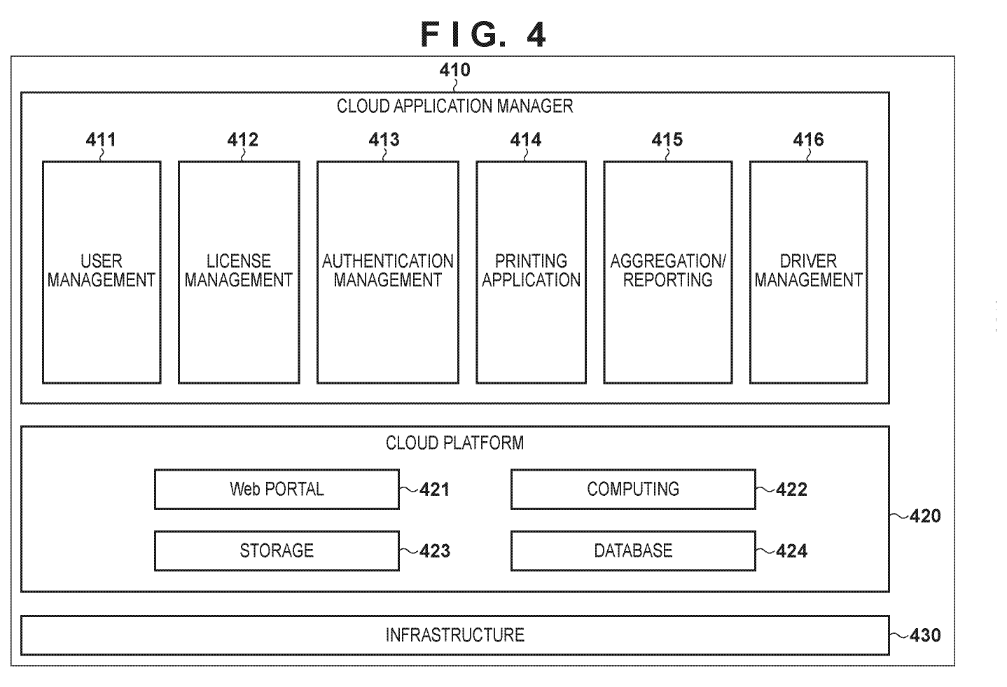

The software configuration of the cloud printing service 100 will be described next with reference to FIG. 4. Infrastructure 430 is the foundation upon which the cloud server provides various services, and is configured including a server, a virtual machine, cloud storage, a network, and an operating system.

A cloud platform 420 is a framework that utilizes infrastructure 430 to provide common basic functions to a cloud application manager 410. In other words, the cloud platform 420 is configured including a web portal 421, computing 422, cloud storage 423, and a database 424.

The cloud application manager 410 is a group of various applications that run on the cloud platform 420. The cloud application manager 410 is configured including user management 411, license management 412, authentication management 413, a printing application 414, aggregation/reporting 415, and driver management 416.

User management 411 centrally manages user information on the cloud printing service 100. Users are registered and deleted through an operation panel of the image forming apparatus 200. User management 411 manages the user information using the database 424. User management 411 also manages the identification information of users in association with the identification information of available models among the image forming apparatuses registered in the printing system. Note that a user ID, information about the image forming apparatus, and tenant information are stored in the database 424. User management 411 is also a web application that provides an API for accepting user authentication instructions from user login authentication 331, which runs on the image forming apparatus 200.

License management 412 is a web application that provides a web service screen for centrally managing the applications on the cloud printing service 100 using the web portal 421. Through this web service screen, the user can install and uninstall applications to be managed, as well as register licenses for the applications. License management 412 is also a web application that provides an API for accepting license registration instructions from the user login authentication 331 and the application management 322, which run on the image forming apparatus 200. There are cases where license registration instructed by the application management 322 of the image forming apparatus 200 is successful. In such a case, license management 412 obtains an application that uses the cloud printing service and that runs on the image forming apparatus 200 from the cloud storage 423 and provides the application to the image forming apparatus 200.

Authentication management 413 is a web application that provides a web service screen for setting the user login authentication method using the web portal 421. This web service screen makes it possible to set the user login authentication method for each application centrally managed on the cloud printing service 100. Authentication management 413 manages the user login authentication method using the cloud storage 423 or the database 424. Authentication management 413 is also a web application that provides an API for accepting setting information obtainment instructions from user login authentication 331, which runs on the image forming apparatus 200. Authentication management 413 is also responsible for accessing various web service screens provided by the cloud application manager 410, and user authentication during API calls.

User management 411, license management 412, and authentication management 413, which are run on the cloud printing service 100, and user login authentication 331, which is run on the image forming apparatus 200, are capable of running in tandem. By running in tandem in this manner, it is possible to log in to a device linked to the cloud printing service 100 using the centrally-managed user authentication method and credentials.

The printing application 414 is a web application that instructs a document to be printed and a print settings changing screen to be obtained from cloud printing 333, which is run on the image forming apparatus 200, using the web portal 421. The printing application 414 also provides an API for accepting a print execution instruction. The printing application 414 accepts the instruction to obtain the document to be printed and returns a list of documents to be printed that are present in the cloud storage. The printing application 414 also accepts a print execution instruction and converts a print data into a data format that can be printed by the image forming apparatus 200 using computing 422. The printing application 414 is also a web application that provides an API for accepting print jobs transmitted by email from the information processing terminal 51, and an API for accepting print job obtainment instructions from cloud printing 333. The printing application 414 on the cloud server, and cloud printing 333 executed on the image forming apparatus 200, are capable of running in tandem. By running in tandem, the user can execute the same print workflow in devices linked to the cloud printing service 100.

Aggregation/reporting 415 is a web application that provides an API for accepting job execution results transmitted from cloud scanning 332 and cloud printing 333, which are executed on the image forming apparatus 200, using the web portal 421. The aggregation/reporting 415 is also a web application that performs processing for aggregating the received job execution results and providing a web service screen that displays the aggregation results using computing 422.

Note that the various web service screens and APIs provided by the cloud application manager 410 are managed individually on a tenant-by-tenant basis. For example, a different URL is generated for each tenant. The various types of data managed by the cloud application manager 410 are also managed individually on a tenant-by-tenant basis. Driver management 416 is a web application that provides a printer driver selection screen to a PC application 530, which is run on the information processing terminal 51, using the web portal 421. The printer driver selection screen is displayed individually on a user-by-user basis.

### Software Configuration of Information Processing Terminal

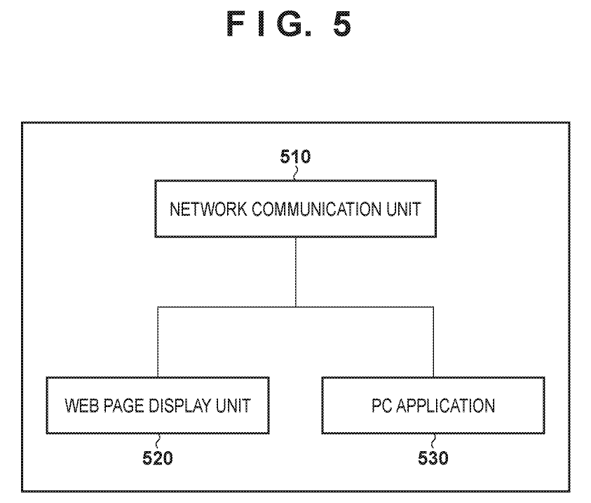

The software configuration of the information processing terminal 51 will be described next with reference to FIG. 5. A program running on the information processing terminal 51 is configured including a network communication unit 510, a web page display unit 520, and the PC application 530. The network communication unit 510 (an example of a “first communication unit”) is a module for data communication with the cloud printing service 100 connected over a network (10 or 20). The web page display unit 520 is a web browser, for example, which displays various web service screens provided by the cloud printing service 100 and accepts user operations through those screens.

The PC application 530 displays screens and accepts operations made in the screens. The PC application 530 generates print data in accordance with instructions from an end user, and transmits the print data (also called “submitted data” hereinafter) to the cloud printing service 100 through the network communication unit 510. The PC application 530 is also used for installing drivers in the information processing terminal 51. In other words, the PC application 530 obtains driver information through driver management 416 of the cloud printing service 100, and obtains and installs drivers stored in the information processing apparatus 110.

### Sequence of Procedure for Registering Image Forming Apparatus 200 with Cloud Print Service 100

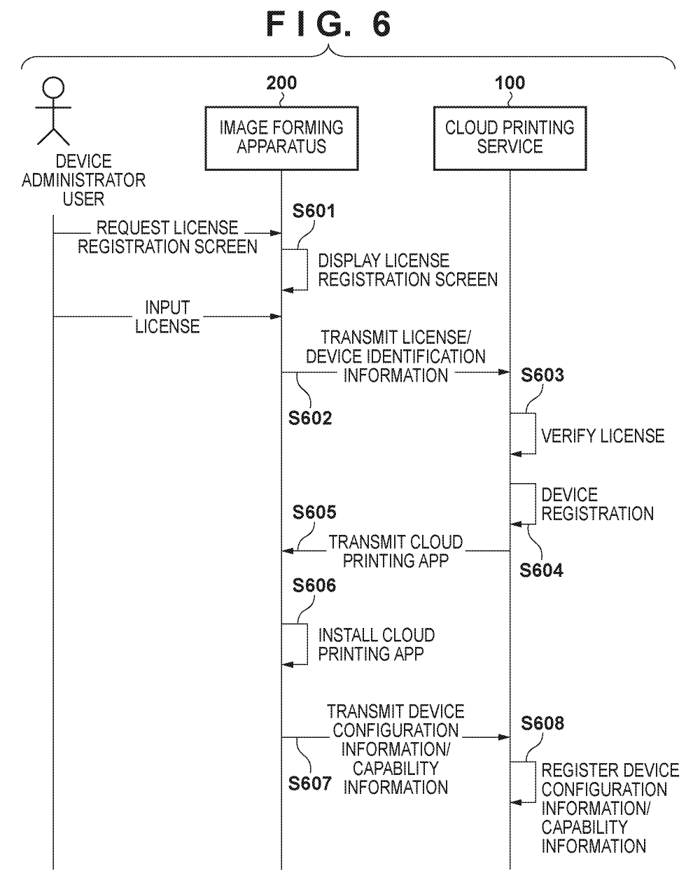

The flow of a sequence through which the image forming apparatus 200 is registered with the cloud printing service 100 and an application for using the cloud printing service 100 is installed in the image forming apparatus 200 will be described next with reference to FIG. 6. This sequence is realized by the image forming apparatus 200 and the cloud printing service 100 executing their respective processing while communicating over the network 10. The processing by the image forming apparatus 200 is realized by programs stored in the ROM 240 being read out into the RAM 230 and executed by the CPU 220. Similarly, the processing by the cloud printing service 100 is realized by programs stored in the ROM 140 being read out into the RAM 130 and executed by the CPU 120. This sequence is executed upon an instruction for execution being made by a device administrator of the image forming apparatus 200 through the operation unit 261.

In step S601, application management 322 of the image forming apparatus 200 receives, from a device administrator, an instruction requesting a registration screen for a usage license of the cloud printing service 100, and displays a license registration screen in the operation unit 261.

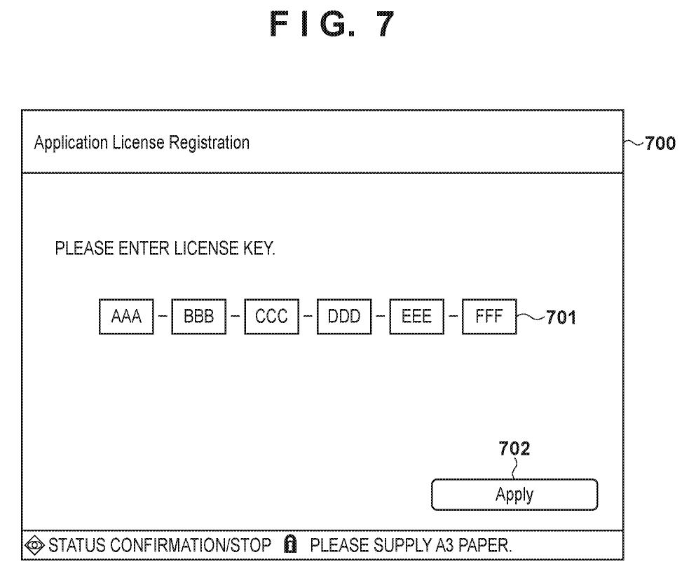

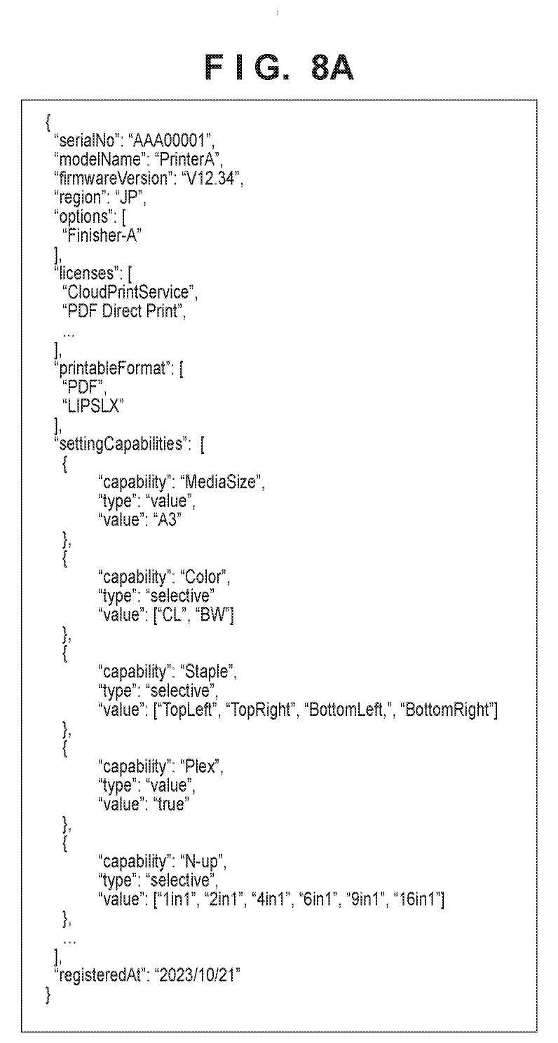

The license registration screen displayed in the operation unit 261 in step S601 will be described with reference to FIG. 7. The device administrator enters a license key for extending the functions of the image forming apparatus 200, which the device administrator has already obtained, into a license key entry field 701 through the operation unit 261. The device administrator can then apply the corresponding license to the image forming apparatus 200 by touching an “apply” icon 702. It is assumed here that the device administrator has entered the usage license key of the cloud printing service 100 in the license registration screen displayed in step S601.

In step S602, along with the entered license key, application management 322 transmits a serial number, as information capable of identifying the individual image forming apparatus 200, to the cloud printing service 100 through the network I/F 270. In step S603, the cloud printing service 100 receives the license key and the serial number from step S602 through the network I/F 170, and license management 412 verifies the license key. If license management 412 determines that the license key is a valid license key for the cloud printing service 100, the sequence moves to step S604.

In step S604, license management 412 registers the image forming apparatus 200 having the serial number received in step S603 in the database 424 as a device with which the cloud printing service 100 can be used. Note that if the same administrator executes the processing from steps S601 to S604 for a plurality of image forming apparatuses 200, the plurality of image forming apparatuses 200 are set to belong to the same tenant.

In step S605, the license management 412 transmits an application for using the cloud printing service 100 to the image forming apparatus 200 through the network I/F 170. In step S606, application management 322 of the image forming apparatus 200 installs the received application for using the cloud printing service in the image forming apparatus 200. Through this processing, cloud printing 333 in FIG. 3 can be used in the image forming apparatus 200.

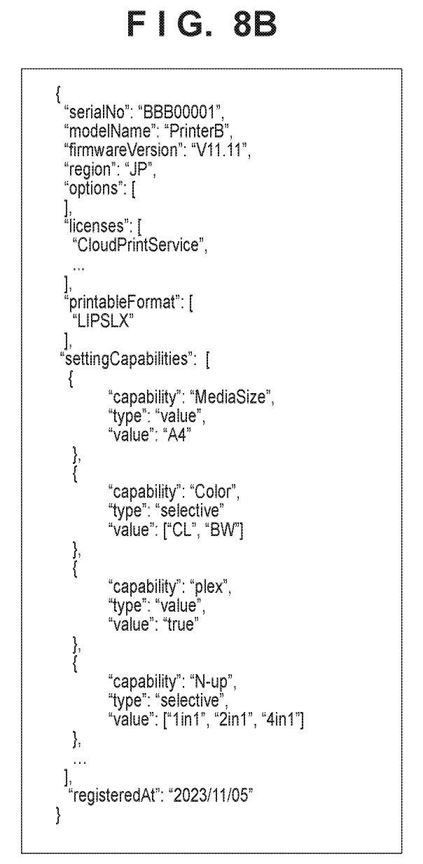

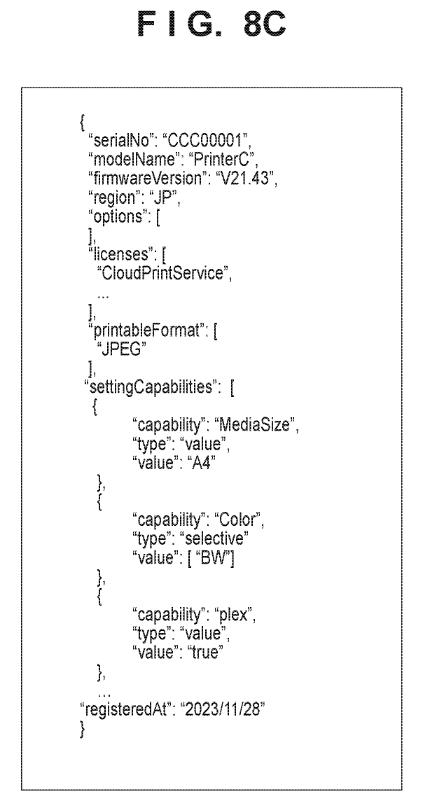

In step S607, cloud printing 333 obtains the configuration information and capability information of the image forming apparatus 200 from the data management module 353, and transmits the information to the cloud printing service 100 through the network I/F 270. FIGS. 8A to 8C illustrate the configuration information and capability information of the image forming apparatus 200 transmitted by cloud printing 333 in step S607.

The configuration information and capability information of the image forming apparatus 200, transmitted by cloud printing 333 in step S607, will be described next with reference to FIGS. 8A to 8C. In the example illustrated in FIGS. 8A to 8C, “serialNo” indicates the serial number, “modelName” indicates the model, and “firmwareVersion” indicates the firmware version. “Region” indicates the country for use, “options” indicates items attached to the image forming apparatus such as a finisher, and “licenses” indicates a list of registered licenses. “printableFormat” indicates data formats that can be printed, and “settingCapabilities” indicates print settings that can be used in the image forming apparatus 200. “registeredAt” indicates a registration date/time, and “settingCapabilities” further includes items “capability”, “type”, and “value” for each of the usable print settings. “capability” indicates the item name of the print settings, “type” indicates the type of the print setting value, and “value” indicates the value range of the print settings that can be used.

More specifically, in FIG. 8A, in the image forming apparatus 200 for which “serialNo” is “AAA00001”, the output paper size setting “MediaSize” is a setting value defined by “value”, and is “A3” here. This indicates that the image forming apparatus 200 for “AAA00001” provides functions such as printing on A3 paper. The color setting “Color” is a setting value defined by “selective”, and here, “CL”, which represents color, and “BW”, which represents black and white, indicate that the value can be selected at the time of printing.

The stapling setting “Staple” is a setting value defined by “selective”. Here, the stapling position being selectable from four locations on the output paper, namely “TopLeft” at the upper-left, “TopRight” at the upper-right, “BottomLeft” at the lower-left, and “BottomRight” at the lower-right, is indicated. A double-sided setting “Plex” indicates that the value is a setting value defined by “value”, and that the value is “true”, i.e., that double-sided printing is possible. A page layout setting “N-up” indicates that the value is a setting value defined by “selective”, and that the value can be selected from page layout setting values “1 in 1”, “2 in 1”, “4 in 1”, “6 in 1”, “9 in 1”, or “16 in 1”.

The differences from FIGS. 8A in FIG. 8B will be described next. In FIG. 8B, in the image forming apparatus 200 for which “serialNo” is “BBB00001”, the setting value for the paper size setting “MediaSize” is “A4”, which provides functions such as printing on A4 paper. The stapling setting “Staple” is not usable, and the page layout setting “N-up” indicates that only “1 in 1”, “2 in 1”, or “4 in 1” can be used. The differences from FIGS. 8A in FIG. 8C will be described next. In FIG. 8C, in the image forming apparatus 200 for which “serialNo” is “CCC00001”, only black and white, i.e., “BW”, can be selected for the color setting “Color”. The stapling setting “Staple” and the page layout setting “N-up” are indicated as unusable.

In step S608, the printing application 414 of the cloud printing service 100 receives the configuration information and capability information of the image forming apparatus 200 through the network I/F 170. The printing application 414 then searches the registered serial numbers for a number that matches the serial number contained in the received configuration information and capability information. The received configuration information and capability information are then registered in the database 424 in association with the matching serial number. The sequence then ends. Executing the sequence as described above results in the image forming apparatus 200 being registered with the cloud printing service 100 as a device capable of using the cloud printing service 100.

### Sequence for Accessing Web Portal of Cloud Print Service and Installing PC Application on Information Processing Terminal

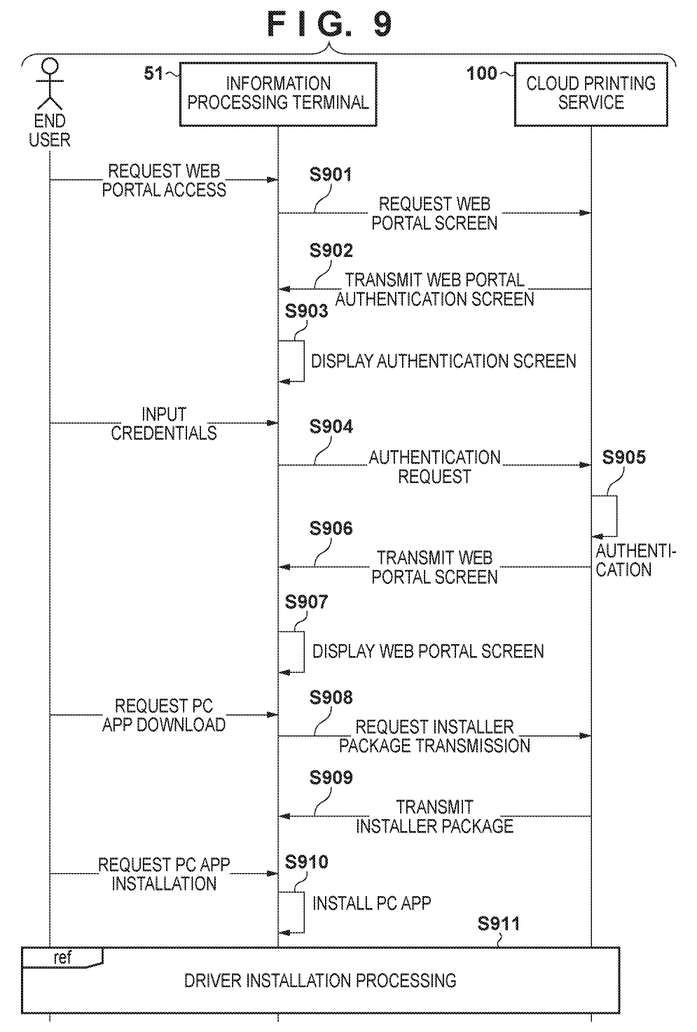

The flow of a sequence for displaying various web portal screens in the information processing terminal 51, and installing a PC application for using the cloud printing service 100 in the information processing terminal 51, will be described with reference to FIG. 9. This sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120. Note that this sequence is executed when an end user of the cloud printing service 100 launches the web page display unit 520, such as a web browser of the information processing terminal 51.

In step S901, the web page display unit 520 receives, from the end user, an access request for access to the web portal 421 of the cloud printing service 100. The web page display unit 520 then requests the screen of the web portal 421 from the cloud printing service 100 through the network communication unit 510.

In step S902, the web portal 421 of the cloud printing service 100 accepts the request for the screen of the web portal 421. The web portal 421 then transmits an authentication screen for logging into the web portal 421 to the information processing terminal 51 through the network I/F 170.

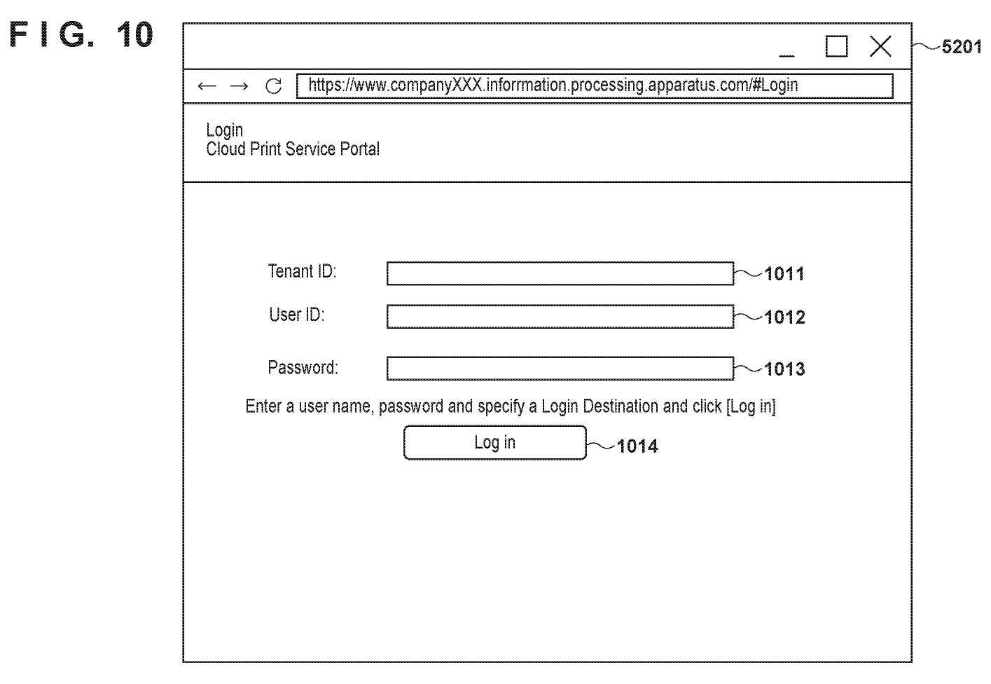

In step S903, the network communication unit 510 of the information processing terminal 51 receives the authentication screen. Then the web page display unit 520 then displays the authentication screen in the operation unit 516. This authentication screen will be described with reference to FIG. 10. Tenant ID, user ID, and password entry fields 1011 to 1013, which are for entering information necessary for authentication of the cloud printing service 100, are arranged on a web page 5201 displayed on the web browser of the information processing terminal 51. A button 1014 for confirming the entries in the entry fields 1011 to 1013 is also provided in the web page 5201. The end user enters credentials for logging into the cloud printing service 100 in the entry fields 1011 to 1013, and touches the button 1014. The web page display unit 520 then detects the button 1014 being touched.

In step S904, the web page display unit 520 transmits an authentication request, along with the credentials entered by the end user, to the cloud printing service 100. The credentials include a user ID, a password, tenant information to which the user belongs, and the like. In step S905, the web portal 421 of the cloud printing service 100 receives the authentication request. The web portal 421 then inputs the received credentials to authentication management 413, and authentication management 413 then verifies the credentials. It is assumed here that the verification of the credentials indicates that the credentials are correct information.

In step S906, the web portal 421 transmits the screen of the web portal 421 to the information processing terminal 51. The network communication unit 510 of the information processing terminal 51 receives the screen of the web portal 421. In step S907, the web page display unit 520 displays the screen of the web portal 421 in the operation unit 516.

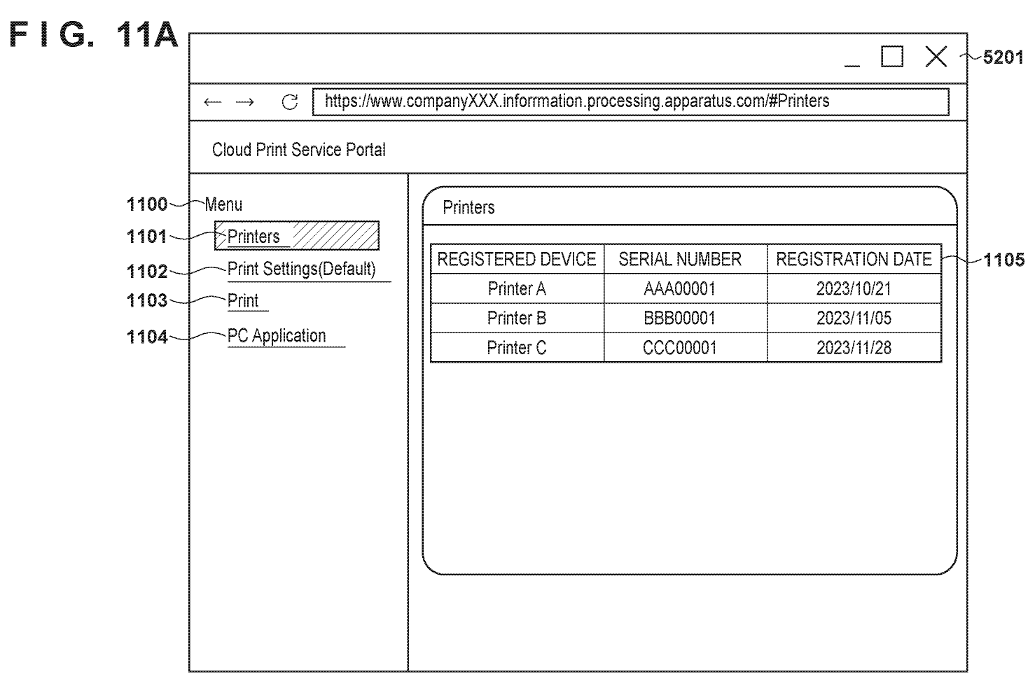

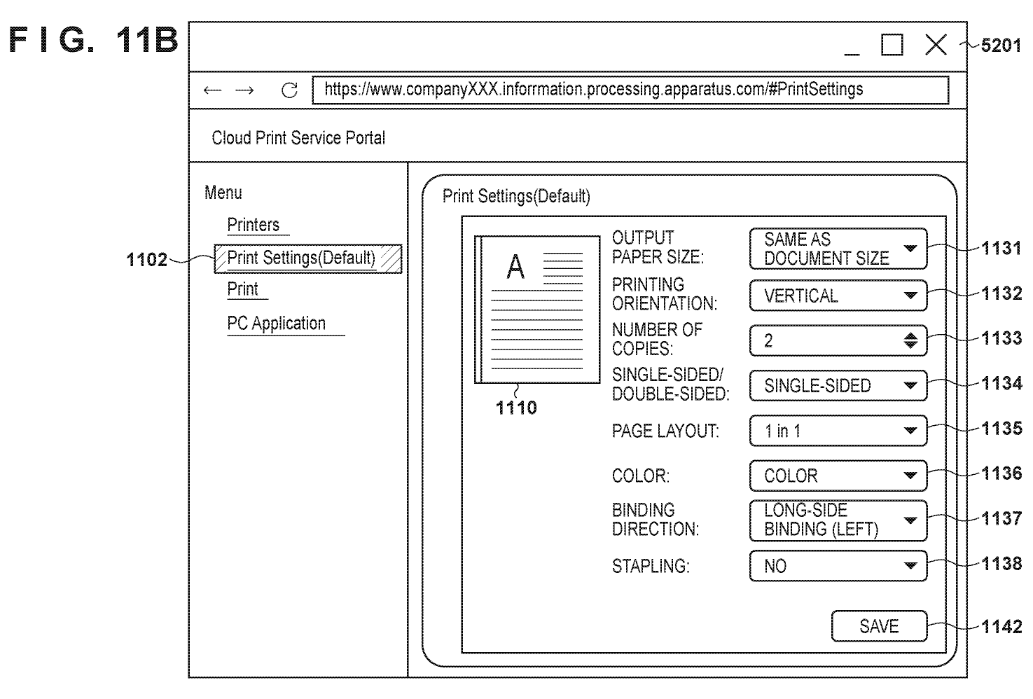

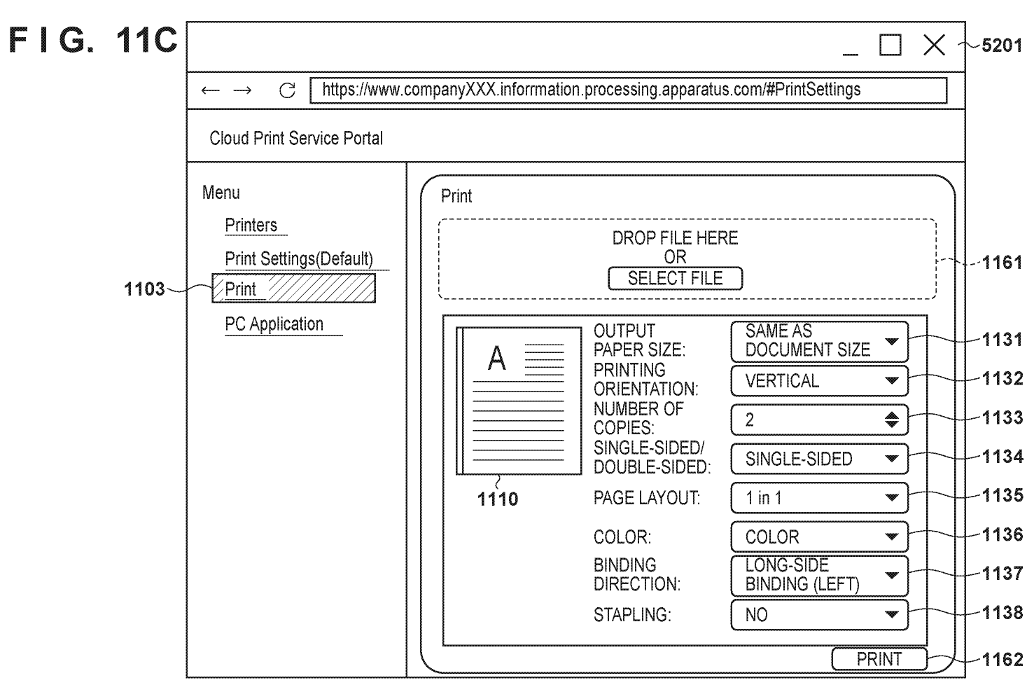

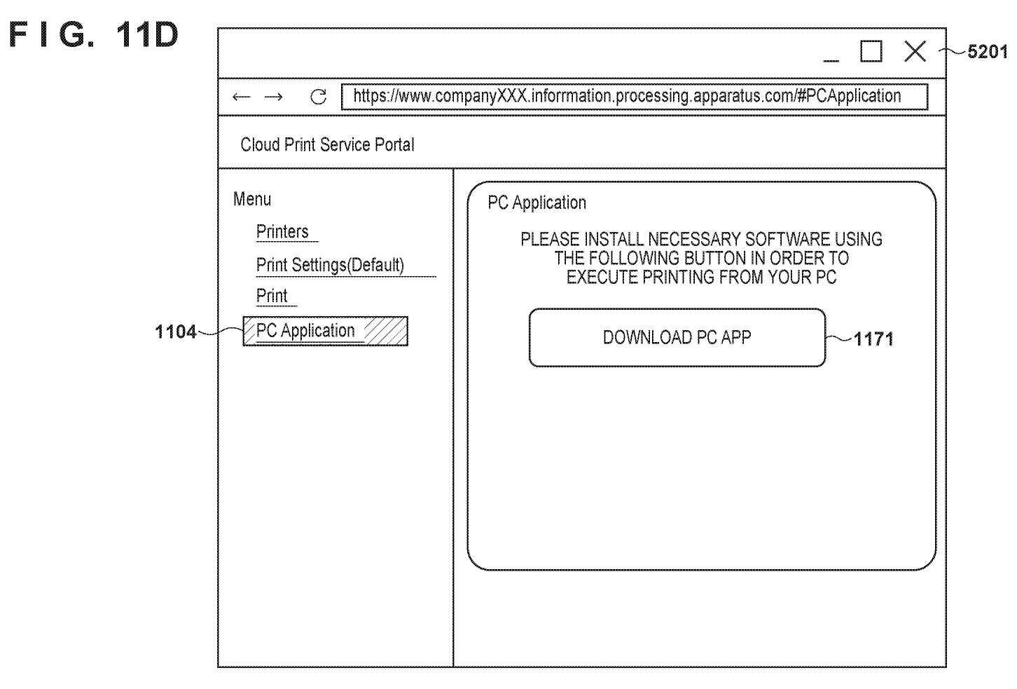

The screen rendered by the web page display unit 520 on the web page 5201 will be described with reference to FIGS. 11A to 11D. A menu 1100 is displayed on the left side of the screen of the web portal 421. A registered printer list menu 1101, a print settings menu 1102, a printing instruction menu 1103, and a settings menu 1104 for the PC application 530 are displayed as sub-menus constituting the menu 1100.

More specifically, FIG. 11A illustrates the screen of the web portal 421 displayed when the end user selects the registered printer list menu 1101. A registered printer list 1105 indicating a list of the image forming apparatuses 200 registered with the tenant to which the end user of the cloud printing service 100 authenticated in step S905 belongs is displayed in this screen. A model name (registered device), serial number, and registration date of the registered printer are displayed in the registered printer list 1105. Note that these display items are merely examples, and other items, e.g., the configuration information or capability information of each registered printer, may be displayed as well.

FIG. 11B illustrates the screen of the web portal 421 displayed when the end user selects the print settings menu 1102. A default print settings list is displayed in this screen. These settings are applied when the end user of the cloud printing service 100 authenticated in step S905 executes printing through a sequence that will be described later. Note that the displayed print settings screen is merely an example, and is displayed in a pull-down menu in which the settings for the output sheet size, printing orientation, number of copies, single-sided/double-sided, page layout, color mode, binding direction, stapling, and the like are set as indicated by 1131 to 1138. A print setting field 1110 indicating the settings and a button 1142 for applying the settings are displayed in the same screen.

FIG. 11C illustrates the screen of the web portal 421 displayed when the end user selects the printing instruction menu 1103. This screen is a screen for the end user of the cloud printing service 100 authenticated in step S905 to submit data to be printed. The screen includes a data submission field 1161, print setting fields 1110 and 1131 to 1138, and a print instruction button 1162. The data submission field 1161 is a field for the end user to drag and drop a file to be printed into the field on the screen, or to submit a file to be printed by a file selection method provided by the OS of the information processing terminal 51. The print setting field 1110 is the same field as that used when displaying the default print settings displayed when the aforementioned print settings menu 1102 is selected. Here, the default print settings set in the print settings menu 1102 are displayed. The end user can also make changes to the displayed settings. By touching the print instruction button 1162, a print instruction is executed in accordance with the details set in the data submission field 1161 and the print setting fields 1110 and 1131 to 1138. Note that the sequence of processing performed when the print instruction is executed will be described in detail later.

FIG. 11D illustrates the screen of the web portal 421 displayed when the settings menu 1104 of the PC application 530 has been selected. A button 1171 for downloading an installer package for setting up the PC application 530 of the cloud printing service 100 is displayed in this screen. The end user of the cloud printing service 100 authenticated in step S905 can download and install the PC application 530 by touching the button 1171. Such processing makes it possible for the end user to submit a desired file as a file to be printed from software installed in the PC, such as word processing software, spreadsheet software, presentation software, or the like. The sequence for installing the PC application 530 and the sequence for instructing printing will be described later.

The descriptions will now return to FIG. 9. In step S908, the web page display unit 520 accepts a touch operation on the screen of the web portal 421. Here, the web page display unit 520 accepts an input for selecting the settings menu 1104 of the PC application 530 illustrated in FIG. 11A. The web page display unit 520 then displays the screen illustrated in FIG. 11D, and accepts a touch operation on the button 1171 of the PC application 530. The web page display unit 520 then transmits, to the cloud printing service 100, a download request for downloading the installer package of the PC application 530.

In step S909, the web portal 421 of the cloud printing service 100 receives the download request for the installer package of the PC application 530. The web portal 421 then obtains the installer package of the PC application 530 held in cloud storage 423 and transmits the installer package to the information processing terminal 51. Note that the format of the installer package of the PC application 530 to be transmitted is executable file format, or a format in which an executable file is compressed, e.g., ZIP format, and is a format that enables installation by the end user using the OS function of the information processing terminal 51. In addition to the installer of the PC application 530, the installer package also includes the tenant information on the tenant that obtained the installer package. The tenant information is information capable of uniquely identifying a tenant, and is the tenant ID, for example.

In step S910, the network communication unit 510 of the information processing terminal 51 receives the installer package of the PC application 530. Then, in the information processing terminal 51, the CPU 512 installs the PC application 530 in response to an instruction accepted from the end user, e.g., an instruction for executing an executable file. Note that the CPU 512 stores the tenant information included in the installer package in a storage medium such as the HDD 150. In step S911, the CPU 512 executes processing for installing the driver used by the PC application 530. The processing sequence will be described in detail later. The sequence then ends. The foregoing sequence makes it possible for the end user of the cloud printing service 100 to install and use the PC application 530 for using the service on the information processing terminal 51.

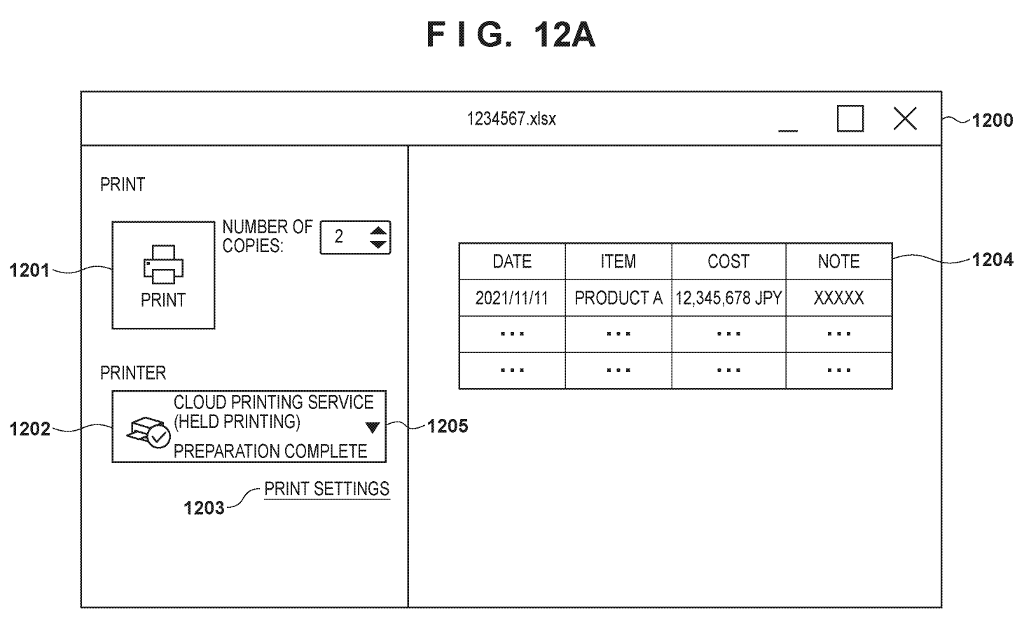

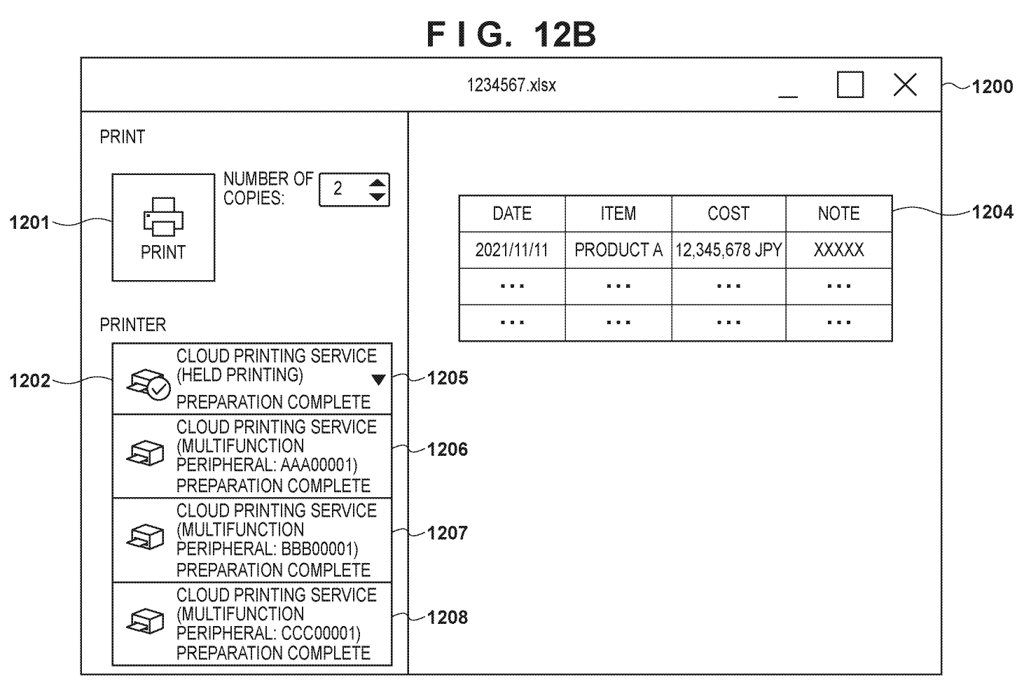

A screen for using the PC application 530 installed in the information processing terminal 51 will be described next with reference to FIG. 12A. Through this screen, the end user can instruct the cloud printing service 100 to print a file opened using spreadsheet software installed in the information processing terminal 51.

More specifically, the end user has opened a file called “1234567.xlsx” in the spreadsheet software, and has opened the print instruction screen in a window 1200. A print instruction button 1201, a printer selection pull-down display 1202, a print settings button 1203, and a print preview display 1204 are displayed in the window 1200. The PC application 530 of the cloud printing service 100 is installed by executing the sequence described earlier with reference to FIG. 9. Upon doing so, an item for using the cloud printing service 100 (described later with reference to FIG. 12B) is displayed in the printer selection pull-down display 1202.

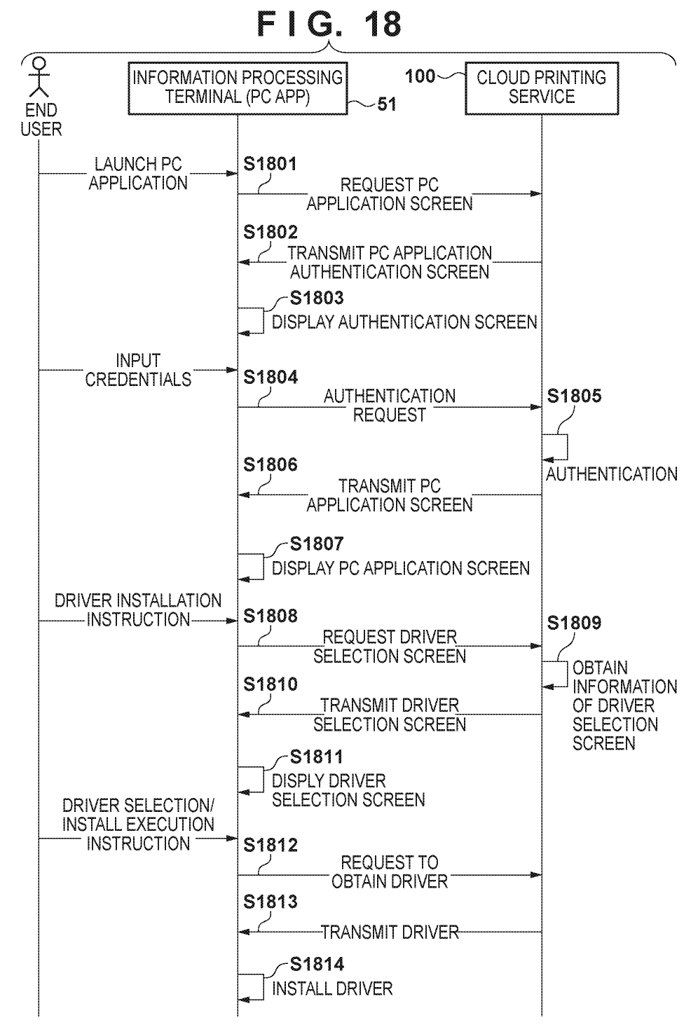

The print settings button 1203 is a button for instructing a print settings screen corresponding to the printer selected in the pull-down display 1202 to be displayed. The flow of displaying the print settings screen and an example of the screen will be described later with reference to FIGS. 18, 19, and 23. When the end user selects the item for using the cloud printing service and touches the print instruction button 1201, the PC application 530 generates print data in which the file which is currently open is printed with the print settings set at that point in time. The network communication unit 510 then transmits (submits) the print data to the cloud printing service 100.

The screen illustrating items that can be selected for using the cloud printing service 100, displayed by selecting the print instruction screen pull-down display 1202 in FIG. 12A, will be described next with reference to FIG. 12B. An icon 1205 indicates an item for executing held printing for the cloud printing service. When the user selects the icon 1205 and operates the print instruction button 1201, the submitted data is held in the cloud printing service 100. The printing can then be executed by any image forming apparatus 200 registered with the cloud printing service 100, at any desired timing, in accordance with the processing flow described later. Meanwhile, icons 1206 to 1208 indicate the image forming apparatuses 200 registered with the cloud printing service 100. In this screen example, the icons 1206 to 1208 correspond to the registered printers “AAA00001”, “BBB00001”, and “CCC00001” described with reference to FIGS. 8A to 8C and FIG. 11A to 11D. When the user selects any one of the icons 1206 to 1208 and operates the print instruction button 1201, printing can be executed by the image forming apparatus 200 corresponding to the selected icon, in accordance with the flow described later.

### Sequence of Processing for Generating Print Job in Cloud Print Service

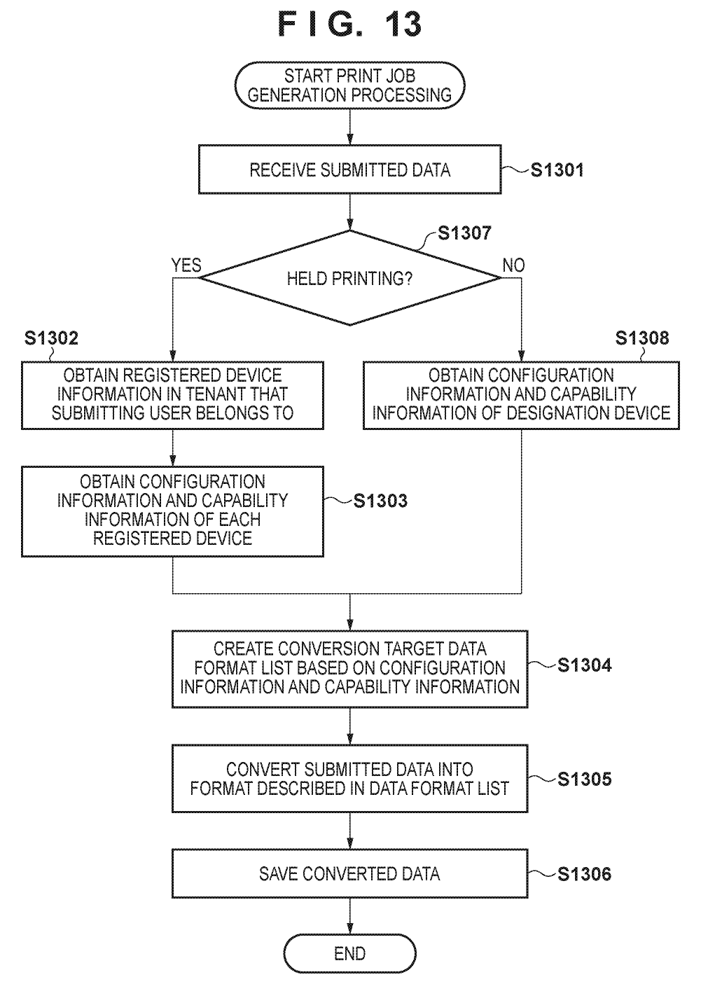

Processing through which the cloud printing service 100 generates a print job on the basis of data submitted from the information processing terminal 51 and saves the print job in association with data converted into a printable format will be described next with reference to FIG. 13. Note that this processing is realized by programs stored in the ROM 140 being read out into the RAM 130 and executed by the CPU 120. This processing is executed when the end user of the cloud printing service 100 submits data to the cloud printing service 100 by operating the screens illustrated in FIGS. 12A and 12B, for example.

In step S1301, the printing application 414 receives the submitted data transmitted from the information processing terminal 51 through the network I/F 170. In step S1307, the printing application 414 determines whether the print type of the submitted data received in step S1301 is held printing. This determination is made according to whether the value of “printType” is “pull” in the submitted data. If the value of “printType” is “pull”, the printing application 414 makes a determination of “Yes”, and the sequence moves to step S1302; if not, the sequence moves to step S1308.

In step S1302, the printing application 414 obtains a list of printers registered in the tenant to which the end user belongs from the database 424. Note that the list of printers obtained matches the printers displayed in the pull-down display 1202 in the registered printer list screen illustrated in FIG. 12A.

In step S1303, the printing application 414 obtains the configuration information and capability information of each registered printer registered in the database 424 in step S608 from the information on the registered printers obtained in step S1302. The sequence then moves to step S1304. Note that the formats of the configuration information and the capability information are, for example, the formats illustrated in FIGS. 8A to 8C for each registered printer.

In step S1308, the printing application 414 executes the following using the information of the registered printer specified by the value of “serialNo” included in the submitted data received in step S1301. In other words, the printing application 414 obtains the configuration information and capability information of the corresponding printer registered in the database 424 in step S608. The sequence then moves to step S1304.

In step S1304, the printing application 414 creates a conversion format list indicating conversion formats in order to convert the submitted data received in step S1301 into a format that can be printed by each device. The conversion format list is created by obtaining the values of “printableFormat” from the configuration information and capability information of each of the devices obtained in S1303 or S1308 and taking the sum of the sets. More specifically, for example, in step S1303, the configuration information and capability information for each device may be obtained with the content illustrated in FIGS. 8A to 8C. In such a case, the values of “printableFormat” for the devices are “PDF, LIPSLX”, “LIPSLX,” and “JPEG”, respectively. Accordingly, the sum of the sets, i.e., “PDF, LIPSLX, JPEG”, is created as the conversion format list.

In step S1305, the printing application 414 converts the submitted data received in step S1301 into each format indicated in the conversion format list generated in step S1304 to generate printable format data. In step S1306, the printing application 414 saves the printable format data converted in step S1305 in cloud storage 423. Note that when the print type is held printing, the printing application 414 stores the identification information of the generated job and information capable of identifying the end user who submitted the data (a user ID or the like) in association with the printable format data as a print job. However, when the print type is not held printing, the printing application 414 stores information of the registered printer to execute printing in addition to the above-described information in association with the printable format data as a print job. The printing application 414 then ends the sequence illustrated in this flowchart.

### Processing Sequence for Image Forming Apparatus to Print Print Job Held in Cloud Print Service

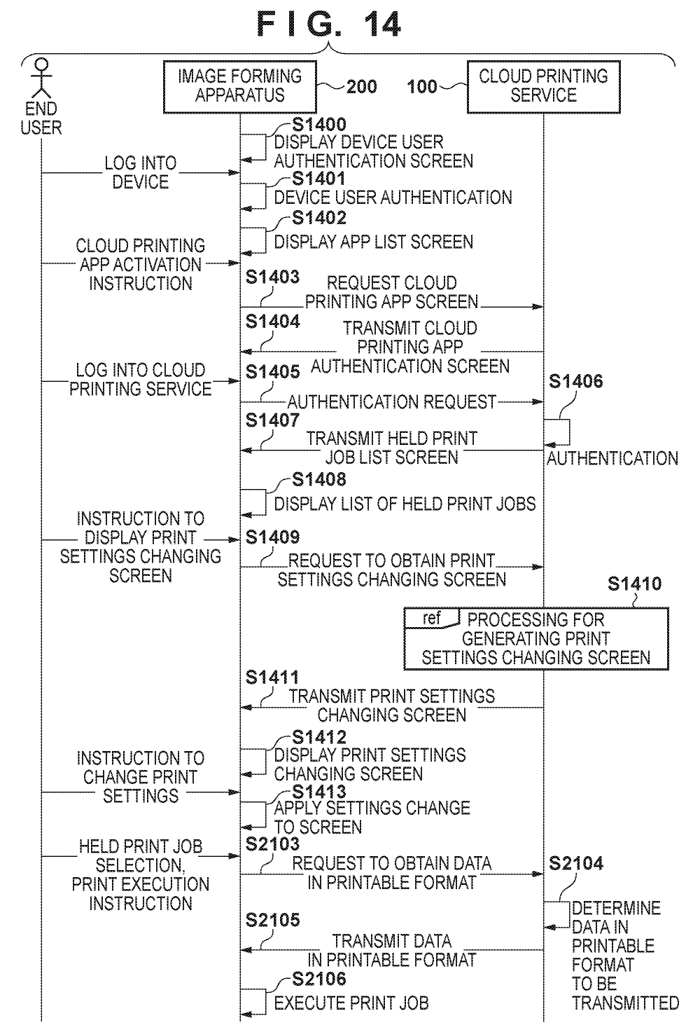

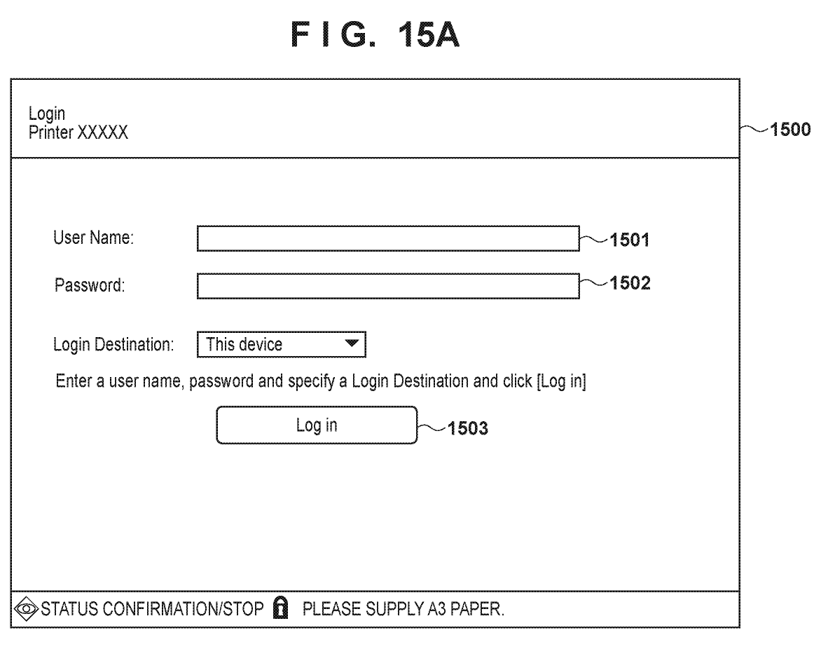

The flow of a sequence of processing by which the image forming apparatus 200 prints a print job for held printing stored in the cloud printing service 100 by executing the sequence illustrated in FIG. 13 will be described next with reference to FIG. 14. This sequence is realized by the image forming apparatus 200 and the cloud printing service 100 executing their respective processing while communicating over the network 10. The processing by the image forming apparatus 200 is realized by programs stored in the ROM 240 being read out into the RAM 230 and executed by the CPU 220. Similarly, the processing by the cloud printing service 100 is realized by programs stored in the ROM 140 being read out into the RAM 130 and executed by the CPU 120. Note that the processing illustrated in this sequence is started when the operation unit 261 of the image forming apparatus 200 is activated by being touched or the like by the end user of the image forming apparatus 200 and the cloud printing service 100.

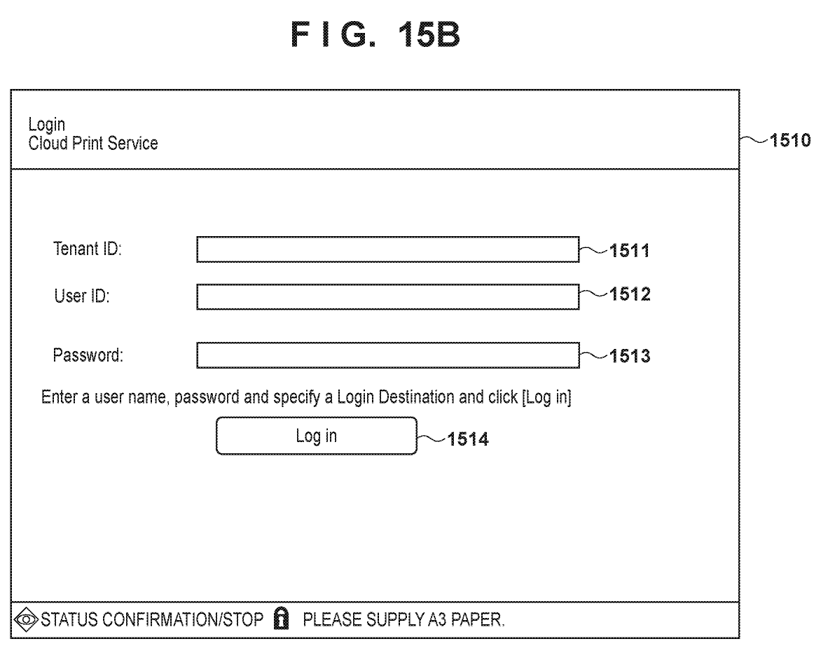

In step S1400, the application platform 340 of the image forming apparatus 200 displays a login screen for logging in to the image forming apparatus 200 in the operation unit 261. The login screen for logging in to the image forming apparatus 200, displayed in step S1400, will be described next with reference to FIG. 15A. A user ID entry field 1501 and a password entry field 1502 are arranged in the screen. The user enters the user ID and password of a user registered in the image forming apparatus 200 using the operation unit 261, and touches a “login” button 1503. Upon doing so, the application platform 340 accepts the touch operation, and can execute the login instruction.

In step S1401, the application platform 340 verifies the user credentials registered in the user management 351 against the user ID and password entered by the end user when the login instruction was made, and performs authentication. In step S1402, if the authentication in step S1401 has succeeded, the application platform 340 displays an application list screen indicating applications installed in the image forming apparatus 200.

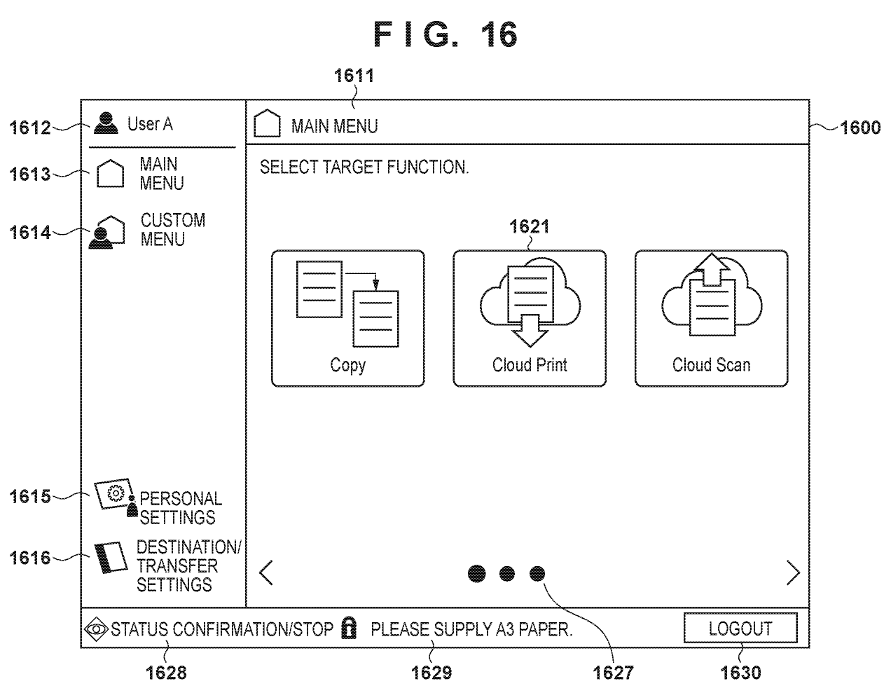

The application list screen of the image forming apparatus 200, displayed in step S1402, will be described next with reference to FIG. 16. An operation panel screen 1600 is configured including, for example, a window title 1611, a username display field 1612, a main menu icon 1613, a custom menu icon 1614, a personal settings icon 1615, and a destination/transfer settings icon 1616. Icons such as a “Copy” icon, a “Cloud Print” icon 1621, and a “Cloud Scan” icon are furthermore displayed in the screen as function icons. These function icons are displayed or hidden depending on the license. The screen is further configured including a “status confirmation/stop” display button 1628 for displaying the status of the image forming apparatus 200, an “error status display field” 1629, and a “logout” button 1630 for logging out the user who is currently logged in. Note that the icon corresponding to the printing application installed in the image forming apparatus 200 in step S606 of FIG. 6 is “Cloud Print” 1621.

The descriptions will return to the sequence illustrated in FIG. 14. In step S1403, the application platform 340 launches cloud printing 333 in response to the end user touching the icon of “Cloud Print” 1621 in the operation panel screen 1600. The launched cloud printing 333 then requests the screen of the cloud printing app from the cloud printing service 100.

The printing application 414 of the cloud printing service 100 requested in step S1404 transmits an authentication screen for logging into the cloud printing service 100 to the image forming apparatus 200 through the network I/F 170. FIG. 15B illustrates an example of this authentication screen. Fields 1511, 1512, and 1513 for entering login information (also referred to as “credentials”), such as the ID of the tenant to which the end user of the cloud printing service 100 belongs, the user ID, and the password, are arranged in the authentication screen. A login instruction button 1514 is also provided in the authentication screen.

In step S1405, the end user enters the login information in the fields 1511 to 1513 of the authentication screen illustrated in FIG. 15B, and touches the login instruction button 1514. In response to this operation, cloud printing 333 transmits the authentication request along with the credentials to the cloud printing service 100.

In step S1406, the printing application 414 of the cloud printing service 100 transmits the received credentials to authentication management 413. Authentication management 413 then verifies the credentials. If the credentials are successfully verified, in step S1407, the printing application 414 generates a held print job list screen indicating held print jobs submitted in advance by the authenticated user, and transmits the screen to the image forming apparatus 200. The list screen may be a list screen of held print jobs created through the sequence illustrated in FIG. 13 and saved in the cloud storage 423 on the basis of data submitted by the authenticated user.

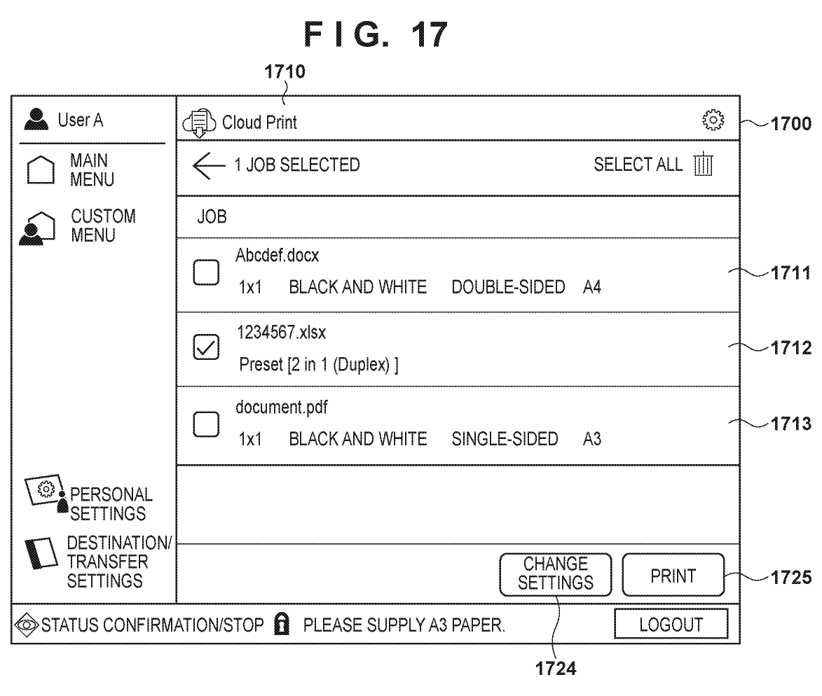

In step S1408, cloud printing 333 of the image forming apparatus 200 displays, in the operation unit 261, the held print job list screen received in step S1407. The screen for displaying the list of held print jobs, displayed in the operation panel of the image forming apparatus 200, will be described next with reference to FIG. 17. A held print job list display screen 1700 is configured including a list of held print jobs 1711 to 1713, a setting change button 1724, and a print button 1725. Of the held print jobs saved through the flow illustrated in FIG. 13, a list of the held print jobs submitted by the end user authenticated in step S1406 is displayed in the held print job list. The end user can select a job to be printed from the list of held print jobs through the operation unit 261, and instruct the printing to be executed by touching the print button 1725. FIG. 17 illustrates a screen in which a held print job 1712 corresponding to the filename “1234567.xlsx” in the submitted data is selected. Note that in the sequence that follows thereafter, it is assumed that the setting change button 1724 has been touched by the end user in this state.

In step S1409, cloud printing 333 accepts an operation of the setting change button 1724 in a state where one of the held print jobs is selected in the screen illustrated in FIG. 17. Cloud printing 333 takes this operation as an instruction to display the print settings changing screen from the end user, and requests the cloud printing service 100 to obtain the print settings changing screen. In step S1410, the printing application 414 of the cloud printing service 100 receives the request to obtain the print settings changing screen transmitted from the image forming apparatus 200 in step S1409, and generates the print settings changing screen in response to the request.

In step S1411, the printing application 414 transmits the print settings changing screen generated in step S1410 to the image forming apparatus 200 through the network I/F 170. In step S1412, cloud printing 333 of the image forming apparatus 200 receives the print settings changing screen through the network I/F 270 and displays the screen on the display of the operation unit 261. In step S1413, cloud printing 333 accepts a print settings changing instruction made by the end user on the screen displayed in step S1412, and applies the instruction to the print settings to be used when executing the print. Here, the print settings changing instruction includes the end user operating a “save” button after performing an operation for changing print setting values or operating a “reset to default” button in the print settings changing screen.

In step S2103, cloud printing 333 accepts a print execution instruction for the held print job from the end user. Then, cloud printing 333 requests the cloud printing service 100 to obtain print data, corresponding to the held print job instructed to be printed by the end user, in a format that can be printed by the image forming apparatus 200. When this obtainment request is made, cloud printing 333 transmits information identifying the image forming apparatus 200 (e.g., a serial number) to the cloud printing service 100. In other words, it is assumed that the printer to which the end user has input the print instruction is “PrinterB” in the list of registered printers. The obtainment request is then transmitted to the cloud printing service 100 in a form in which a serial number “BBB00001” is included.

In step S2104, the printing application 414 of the cloud printing service 100 receives the request to obtain the print data in a format that can be printed by the image forming apparatus 200. The printing application 414 then determines the printable format data to be transmitted to the image forming apparatus 200 that made the request, using the details in the obtainment request. Specifically, the printing application 414 identifies, in the database 424, the configuration information and capability information corresponding to the serial number of the image forming apparatus 200 that made the request, included in the print data obtainment request. In other words, the printing application 414 identifies the configuration information and capability information corresponding to the serial number “BBB00001”.

Next, the printing application 414 identifies the printable format indicated by “Printableformat” using the identified configuration information and capability information. Then, of the data in each printable format stored in cloud storage 423 in step S1306, the printing application 414 determines the data corresponding to the identified format as the printable format data to be transmitted to the image forming apparatus 200 that made the request. In other words, the printing application 414 determines the data converted in the format “LIPSLX” for the submitted data of “1234567.xlsx” as the data that can be printed in the image forming apparatus 200.

In step S2105, the printing application 414 transmits the printable format data determined in step S2104 to the image forming apparatus 200 through the network I/F 170. In step S2106, cloud printing 333 of the image forming apparatus 200 receives the printable format data through the network I/F 270, and issues a print execution instruction through the job/device control module 352. Then, processing for printing the printable format data is executed. The processing then ends.

The procedure for obtaining and installing a printer driver from the cloud printing service 100 on the basis of a designation made by the end user through the PC application 530 installed in the information processing terminal 51 will be described with reference to FIG. 18. This sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120. Note that the processing of this sequence corresponds to the processing of step S911 in FIG. 9, which is started when the end user of the cloud printing service 100 becomes able to operate the PC application 530 installed in the information processing terminal 51.

In step S1801, the PC application 530 of the information processing terminal 51 makes a request for a PC application screen from the cloud printing service 100 through the network communication unit 510. The web portal 421 of the cloud printing service 100 receives the request through the network I/F 170. In step S1802, the web portal 421 transmits the authentication screen to the PC application 530 in response to the request. The PC application 530 of the information processing terminal 51 then receives the authentication screen from the cloud printing service 100. In step S1803, the PC application 530 displays the authentication screen received from the cloud printing service 100. The authentication screen is the same as the authentication screen transmitted to the information processing terminal 51 by the web portal 421, illustrated in FIG. 10. The end user enters their credentials for logging into the cloud printing service 100 in accordance with the screen display, and operates the button 1014 to confirm. The sequence then moves to step S1804.

In step S1804, the PC application 530 transmits the credentials to the cloud printing service 100 and makes an authentication request. Here, the credentials are, for example, identification information that uniquely indicates information about the tenant, ID information of the user, a password, or the like. The web portal 421 of the cloud printing service 100 receives the credentials. In step S1805, the web portal 421 transmits the credentials to authentication management 413. Authentication management 413 verifies the received credentials. Once this verification in this authentication is complete, the sequence moves to step S1806.

In step S1806, the web portal 421 of the cloud printing service 100 transmits the PC application screen to the information processing terminal 51. The PC application 530 of the information processing terminal 51 receives the PC application screen. In step S1807, the PC application 530 displays the PC application screen. Then, in response to the PC application 530 accepting a driver installation instruction from the user, the sequence moves to step S1808.

In step S1808, the PC application 530 makes a request for a driver selection screen to the cloud printing service 100. Driver management 416 of the cloud printing service 100 then receives the request. In step S1809, the driver management 416 obtains information for generating the driver selection screen from the database 424 (an example of a “storage unit”). The information includes driver information for models that can be used by the user who made the request, static resources for the driver selection screen, and the like. The driver selection screen is generated next. Note that the driver selection screen may be generated by either the PC application 530 or the cloud printing service 100. A sequence of processing for generating the driver selection screen will be described in detail later. In step S1810, the driver management 416 transmits the driver selection screen to the information processing terminal 51 through the network I/F 170 (an example of a “second communication unit”). The PC application 530 of the information processing terminal 51 then receives the driver selection screen. In step S1811, the PC application 530 displays the driver selection screen.

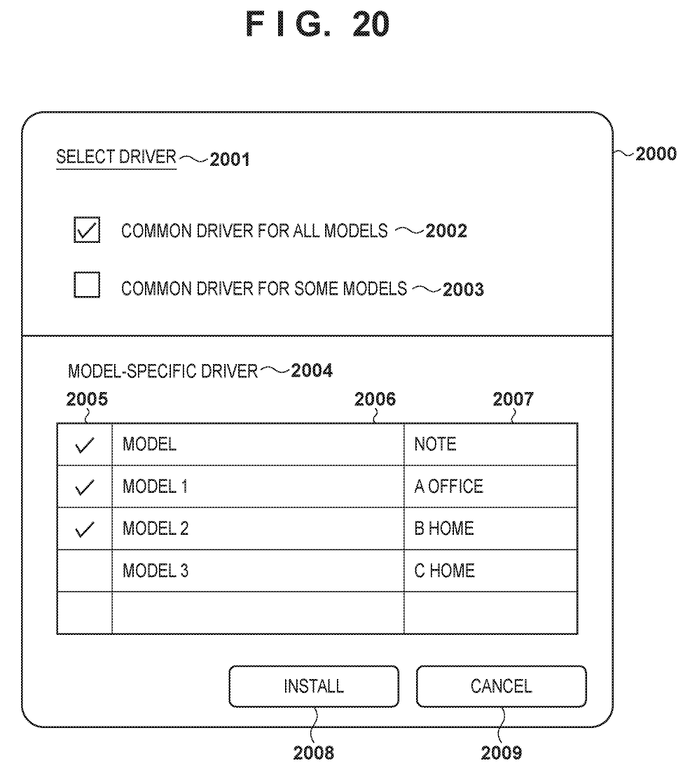

A driver selection screen 2000 obtained from the cloud printing service 100 and displayed by the PC application 530 will be described with reference to FIG. 20. The driver selection screen 2000 includes a pane 2001 for selecting a common driver, and a pane 2004 for selecting a model-specific driver. The driver selection screen 2000 also includes an execute button 2008 for instructing the driver selected in the screen to be installed, and a cancel button 2009 for cancelling the installation processing.

The pane 2001 includes a checkbox 2002 (an example of a “first object”) and a checkbox 2003 (an example of a “second object”). The checkbox 2002 is a checkbox for selecting a driver that can be used by all models but has few function settings. On the other hand, the checkbox 2003 is a checkbox for selecting a common driver through which high-performance print settings limited to some models can be used.

The pane 2004 is a region for selecting a driver of a model that does not support the stated common driver through which high-performance print settings limited to some models can be used, and for selecting a driver capable of high-performance print settings for each model. Specifically, the pane 2004 includes a model-specific driver selection column 2005 (an example of a “third object”), a model name display column 2006, and a notes column 2007.

The model-specific driver selection column 2005 is a column for selecting a driver corresponding to the model displayed in the model name display column 2006. The model list displayed in the model name display column 2006 is the list obtained from the cloud printing service 100 in step S1809. The content of this list is different for each user, depending on the model associated with the tenant and whether the tenant administrator has set the device to be usable by the user. The notes column 2007 displays note information for the device corresponding to the model name display column 2006. Installation location information can be given as an example of the note information. Note that the model name display column 2006 and the notes column 2007 are examples of a “list format”.

The PC application 530 also accepts operations for adding checkmarks to the checkboxes 2002 and 2003 and the model-specific driver selection column 2005, and the operation of the execute button 2008. The sequence then moves to step S1812. On the other hand, if the PC application 530 has accepted an operation of the cancel button 2009, the driver installation processing illustrated in FIG. 18 ends.

The descriptions will now return to FIG. 18. In step S1812, the PC application 530 makes a request to obtain the selected driver to the cloud printing service 100. Note that the driver may be obtained directly from a server such as the cloud storage service 110. Driver management 416 of the cloud printing service 100 then receives the request. In step S1813, driver management 416 transmits the driver to the information processing terminal 51. The PC application 530 of the information processing terminal 51 then receives the driver. In step S1814, the PC application 530 sets up the obtained driver. The processing then ends.

Through the sequence described above, the end user of the cloud printing service 100 installs the printer driver in the information processing terminal 51. Once the printer driver is installed in this manner, the user can use high-performance cloud print settings when submitting a print job.

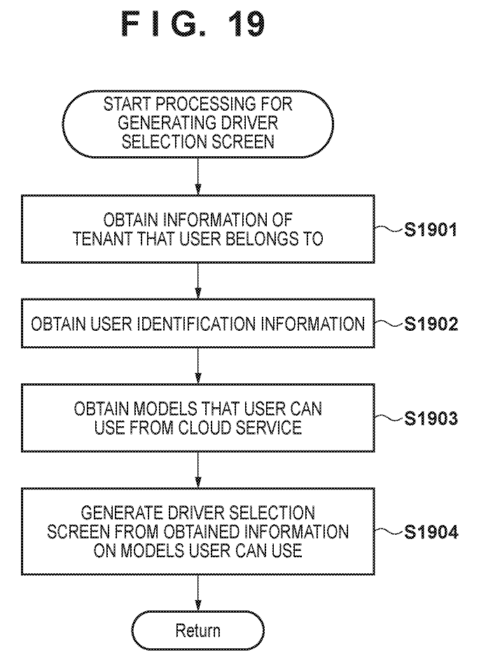

The flow of a sequence through which the PC application 530 of the information processing terminal 51 generates the driver selection screen using the information on models available to the user, obtained from the cloud printing service 100, will be described in detail with reference to FIG. 19. This processing is realized by a program stored in the ROM 514 being read out into the RAM 513 and executed by the CPU 512. This processing is processing performed when the driver selection screen generation processing of step S1809 of FIG. 18 is executed by the information processing terminal 51 instead of the cloud printing service 100.

In step S1901, the PC application 530 obtains the tenant information on the tenant to which the user belongs. The tenant information is information capable of uniquely identifying the tenant to which a user belongs, for example. The tenant information may be information used in the authentication processing in step S1804 of FIG. 18, or information set in advance in the PC application 530. In step S1902, the PC application 530 obtains the identification information of the user. The identification information of the user is information capable of uniquely identifying the user within the tenant obtained in S1901. The identification information of the user may be information used in the authentication processing in step S1804 of FIG. 18.

In step S1903, the PC application 530 obtains model information on the models that can be used by the user from the cloud printing service 100. The models that can be used by the user correspond to the model information of devices, among the devices associated with the tenant to which the user belongs, that the user is allowed to use or that are not restricted from being used. In step S1904, the PC application 530 generates the driver selection screen using the model information on the models that can be used by the user, obtained in step S1903. The information on the models that can be used by the user is used to generate the items in the model name display column 2006 and the notes column 2007 in the driver selection screen 2000 illustrated in FIG. 20. The sequence then moves to step S1811 of FIG. 18.

### Actions and Effects

According to the image forming system 1 described above, a printer driver suited to each user can be efficiently installed as the printer driver to be used when transmitting print jobs from the information processing terminal 51 to the cloud printing service 100.

### First Variation

A first variation will describe a variation on the method for generating the driver selection screen. More specifically, if the permissions of the user correspond to those of tenant administrator, the user can use all the models associated with the tenant. Accordingly, when the user requests to obtain the model information on the models that can be used, all the model information is obtained. In the first variation, descriptions of parts where configurations, processing sequences, and the like are the same as in the foregoing embodiment will be omitted, and only the differences will be described.

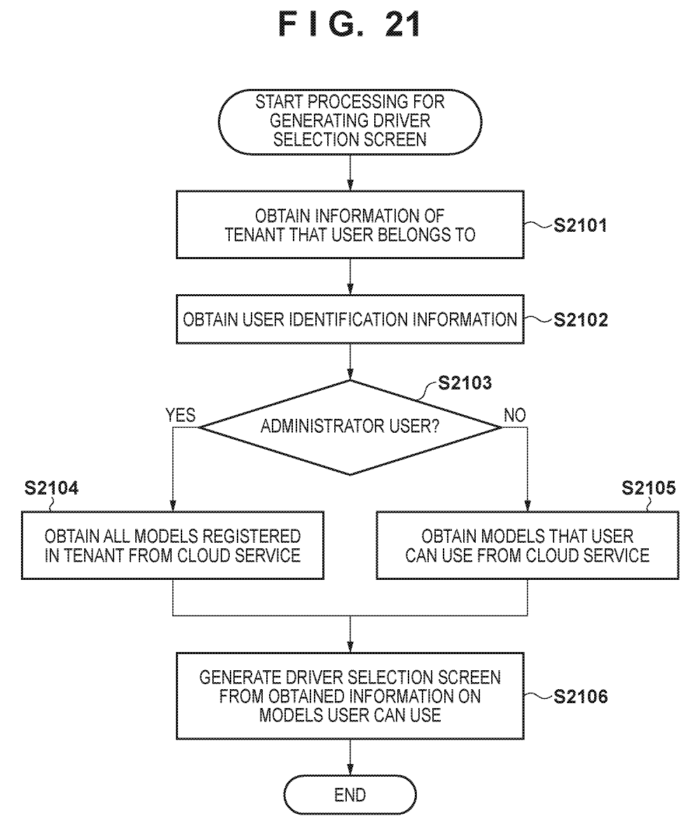

A flowchart illustrating the generation of the driver selection screen that enables drivers corresponding to all models to be selected for a situation where the user is the tenant administrator in step S1811 will be described next with reference to FIG. 21. This flowchart is executed instead of the flowchart of FIG. 19 in the embodiment. This processing is realized by a program stored in the ROM 514 being read out into the RAM 513 and executed by the CPU 512.

In step S2101, the PC application 530 obtains the tenant information on the tenant to which the user belongs. The tenant information is information capable of uniquely identifying the tenant to which a user belongs, for example. The tenant information is also information used in the authentication processing in step S1804 of FIG. 18, or information set in advance in the PC application 530, for example. In step S2102, the PC application 530 obtains the identification information of the user. The identification information of the user is information capable of uniquely identifying the user within the tenant obtained in S2101, for example. The identification information of the user is information used in the authentication processing in step S1804 of FIG. 18, for example.

In step S2103, the PC application 530 determines whether the user is the administrator of the tenant using the identification information of the user obtained in step S2102. If the PC application 530 determines that the user is the administrator, the sequence moves to step S2104. In step S2104, the PC application 530 obtains information on all models registered in the tenant from the cloud printing service 100. The sequence then moves to step S2106.

On the other hand, if in step S2103 the PC application 530 determines that the user is not the administrator, the sequence moves to step S2105. In step S2105, the PC application 530 obtains model information on the models that can be used by the user from the cloud printing service 100. The models that can be used by the user correspond to the model information of devices, among the devices associated with the tenant to which the user belongs, that the user is allowed to use or that are not restricted from being used, for example. The sequence then moves to step S2106.

In step S2106, the PC application 530 generates the driver selection screen using the model information on the models obtained in step S2104 or step S2105. The information on the models that can be used by the user is used to generate the items in the model name display column 2006 and the notes column 2007 in the driver selection screen 2000 illustrated in FIG. 20. The sequence then moves to step S1811 of FIG. 18.

### Actions and Effects

According to the first variation, according to the user’s permissions, different types of printer drivers can be efficiently installed as printer drivers to be used when transmitting print jobs from the information processing terminal 51 to the cloud printing service 100.

### Second Variation

In a second variation, when obtaining the models that can be used by the user, the PC application 530 obtains not only model information on models for which the individual user has permissions for use, but also model information on models for which a group to which the user belongs has permissions for use. Note that a group is created for each floor in a workplace, for example. User management 411 also manages identification information of the group in association with the models of the image forming apparatuses registered in the printing system that can be used by that group.

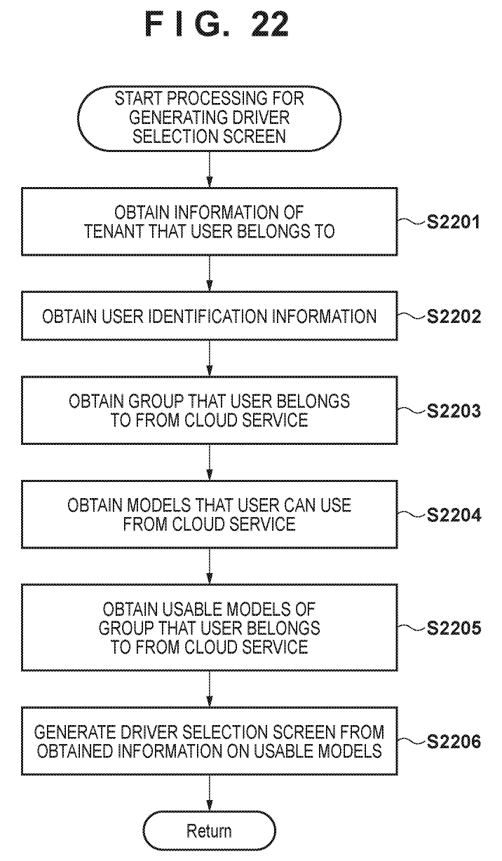

A flowchart illustrating processing for generating the driver selection screen according to the second variation will be described next with reference to FIG. 22. This flowchart is executed instead of the flowchart of FIG. 19 in the embodiment. This processing is realized by a program stored in the ROM 514 being read out into the RAM 513 and executed by the CPU 512.

In step S2201, the PC application 530 obtains the tenant information on the tenant to which the user belongs. The tenant information is information capable of uniquely identifying the tenant to which a user belongs, for example. The tenant information is also information used in the authentication processing in step S1804 of FIG. 18, or information set in advance in the PC application 530, for example. In step S2202, the PC application 530 obtains the identification information of the user. The identification information of the user is information capable of uniquely identifying the user within the tenant obtained in S2101, for example. The identification information of the user is obtained as information used in the authentication processing in step S1804 of FIG. 18, for example.

In step S2203, the PC application 530 obtains group information on the group to which the user belongs from the cloud printing service 100. The group of the user consists of one or more users belonging to the tenant. The group information is a group name, an ID capable of uniquely identifying the group, or the like, for example. In step S2204, the PC application 530 obtains model information on the models that can be used by the user from the cloud printing service 100. The models that can be used by the user correspond to the model information of devices, among the devices associated with the tenant to which the user belongs, that the user is allowed to use or that are not restricted from being used, for example.

In step S2205, the PC application 530 obtains model information on the models that can be used by the group to which the user belongs from the cloud printing service 100. The models that can be used by the group correspond to the model information of devices, among the devices associated with the tenant in which the group is registered, that the group is allowed to use or that are not restricted from being used, for example. In step S2206, the PC application 530 generates the driver selection screen using the model information on the models obtained through the processing of steps S2204 and S2205. The information on the models that can be used by the user and the information on the models that can be used by the group are used to generate the items in the model name display column 2006 and the notes column 2007 in the driver selection screen 2000 illustrated in FIG. 20. The sequence then moves to step S1811 of FIG. 18.

### Actions and Effects

According to the second variation, permissions for models that can be used by a group can be granted all at once to a plurality of people for a printer driver to be used when transmitting print jobs from the information processing terminal 51 to the cloud printing service 100. Accordingly, different types of printer drivers according to the permissions of the user and the permissions of the group can be efficiently installed.

### Third Variation

In the foregoing embodiment, when the PC application 530 installs the driver in the information processing terminal 51, the user enters their credentials twice, as indicated in step S903 of FIG. 9 and step S1803 of FIG. 18. A third variation reduces the burden on the user for entering their credentials multiple times by saving the credentials entered the first time. In the third variation, descriptions of parts where configurations and processing sequences are the same as in the foregoing embodiment will be omitted, and only the differences will be described.

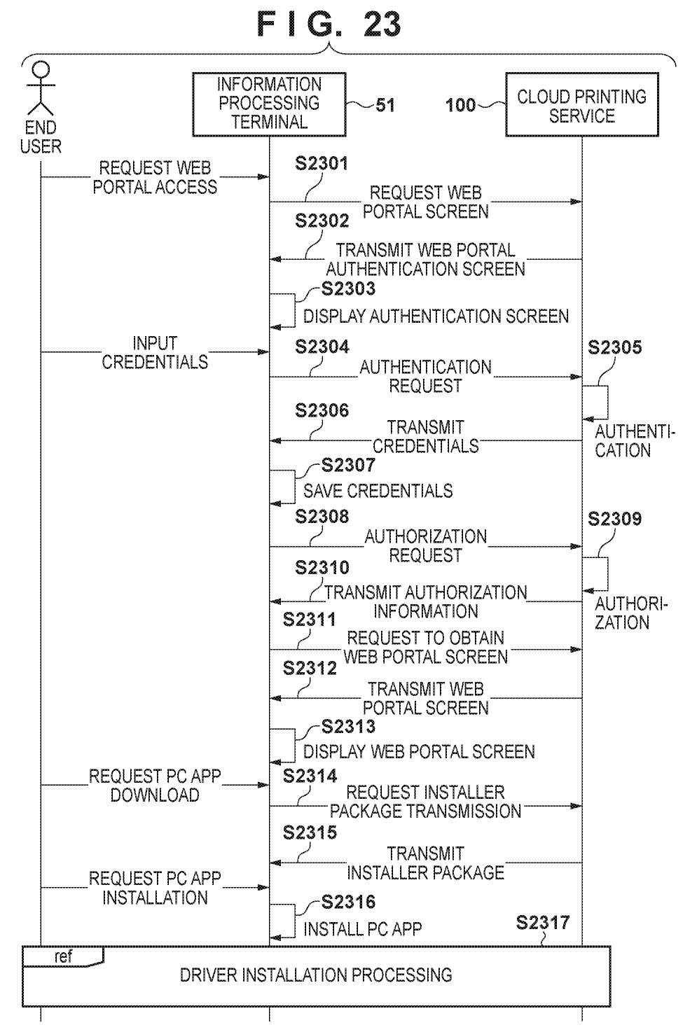

The flow of a sequence for displaying various web portal screens in the information processing terminal 51, and installing a PC application for using the cloud printing service 100 in the information processing terminal 51, will be described with reference to FIG. 23. This sequence is performed instead of the sequence of FIG. 9 in the embodiment, and adds processing for storing the credentials in the browser cache to the processing of the embodiment.

Note that this sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120. Note that this sequence is executed when an end user of the cloud printing service 100 launches the web page display unit 520, such as a web browser of the information processing terminal 51.

Steps S2301 to S2305 are the same as steps S901 to S905 in FIG. 9, and will therefore not be described. In step S2306, the web portal 421 of the cloud printing service 100 tokenizes or encrypts the verified credentials, and transmits the credentials to the information processing terminal 51 using the network I/F 170. The web page display unit 520 of the information processing terminal 51 then receives the credentials using the network communication unit 510.

In step S2307, the web page display unit 520 saves the received credentials in the browser. A cookie is used to save the credentials, for example. Note that the storage destination may be in-memory, local storage, session storage, or the like. In step S2308, the web page display unit 520 transmits an authorization request along with the credentials saved in the browser in step S2307 to the cloud printing service 100. The web portal 421 of the cloud printing service 100 then receives the credentials and the authorization request.

In step S2309, the web portal 421 transmits the received credentials to authentication management 413. Authentication management 413 verifies the received credentials. If the authentication is determined to be successful, authentication management 413 performs authorization. Authorization information of the user authorized in step S2310 is transmitted to the information processing terminal 51. The web page display unit 520 of the information processing terminal 51 then receives the authorization information. In step S2311, the web page display unit 520 transmits an obtainment request for the web portal screen, along with the authorization information obtained in step S2310, to the cloud printing service 100. The web portal 421 of the cloud printing service 100 then receives the obtainment request and the authorization information.

In step S2312, the web portal 421 transmits the screen of the web portal 421 to the information processing terminal 51. The web page display unit 520 of the information processing terminal 51 then receives the screen. In step S2313, the web page display unit 520 displays the screen of the web portal 421. The sequence then moves to step S2314. The processing of steps S2314 to S2317 is the same as the processing of steps S908 to S911, and will therefore not be described. However, because step S2317 differs in part from step S911, the sequence of the processing in step S2317 will be described in detail hereinafter.

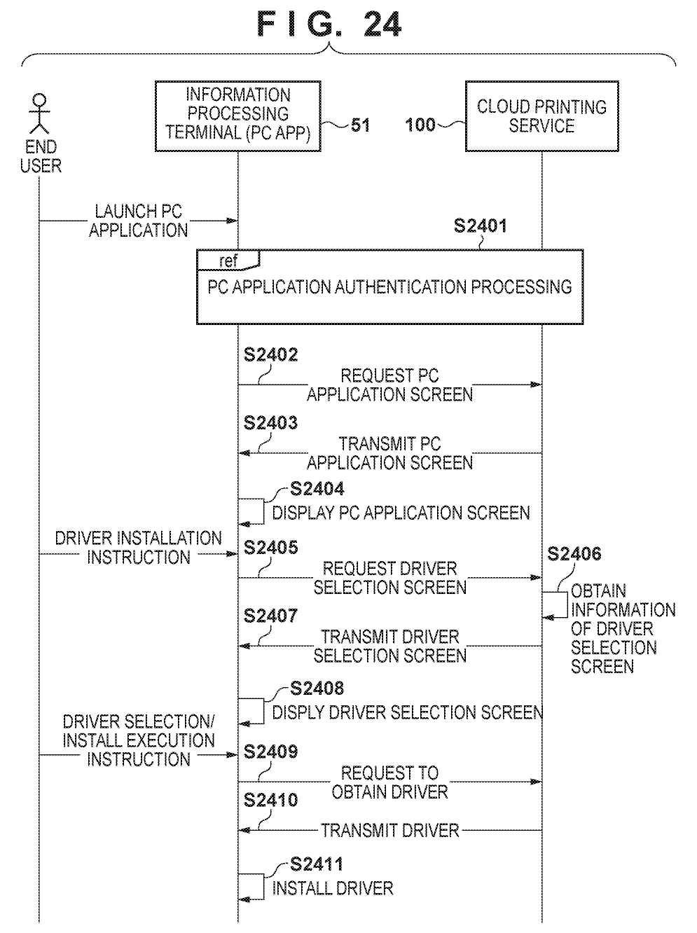

The processing of step S2317 in FIG. 23 will be described in detail with reference to FIG. 24. The processing is a sequence of processing performed up to the PC application 530 installed in the information processing terminal 51 obtaining a printer driver designated by the end user from the cloud printing service 100 and installing the printer driver. This sequence is executed instead of the sequence illustrated in FIG. 18 and performed in the embodiment. This sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120.

In step S2401, if credentials saved in the processing of step S2307 of FIG. 23 are present, the processing of newly accepting the credentials of the user in order to authenticate the user in the cloud printing service 100 is omitted. The cloud printing service 100 then authorizes the PC application 530 to obtain the screen of the PC application.

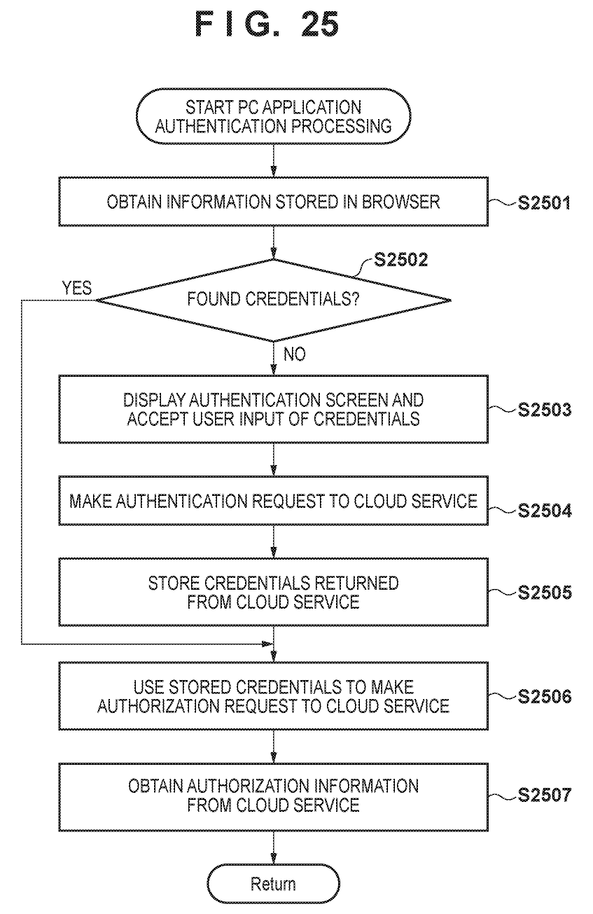

The processing sequence performed in such a case will be described in detail with reference to FIG. 25. This flowchart is executed mainly by the PC application 530. This processing is realized by programs stored in the ROM 514 of the information processing terminal 51 being read out into the RAM 513 and executed by the CPU 512.

In step S2501, the PC application 530 obtains the information stored in the browser. In step S2502, the PC application 530 determines whether credentials saved by the web page display unit 520 in step S2307 of FIG. 23 are present. If the PC application 530 determines that the credentials are present, the sequence moves to step S2506; if not, the sequence moves to step S2503.

Steps S2503 to S2505 are the same as steps S2303 to S2307 in FIG. 23 in the embodiment, and will therefore not be described. In step S2506, the PC application 530 transmits the credentials stored in the browser and an authorization request for obtaining the PC application screen to the cloud printing service 100. If the PC application 530 determines in step S2502 that the credentials are present, the transmitted credentials are the credentials saved in step S2307. On the other hand, if the PC application 530 determines in step S2502 that the credentials are not present, the transmitted credentials are the credentials saved in step S2505. In step S2507, the PC application 530 obtains the result of the authorization request made in step S2506 as authorization information from the cloud printing service 100. The sequence then moves to step S2402 of FIG. 24.

The descriptions will now return to FIG. 24. In step S2402, the PC application 530 transmits the authorization information obtained in step S2401 and the request for the PC application screen to the cloud printing service 100. In step S2403, the web portal 421 of the cloud printing service 100 receives the authorization information and the request. The web portal 421 then transmits the PC application screen to the PC application 530. Then, the PC application 530 of the information processing terminal 51 receives the PC application screen.

In step S2404, the PC application 530 displays the PC application screen received from the cloud printing service 100. Then, in response to the PC application 530 accepting an operation corresponding to a driver installation instruction from the user, the sequence moves to step S2405. Steps S2405 to S2411 are the same as steps S1808 to S1814, and will therefore not be described. The processing then ends.

### Actions and Effects

According to the third variation, the burden on the user for entering the credentials multiple times can be lightened by saving the credentials entered the first time during the driver installation processing by the PC application 530 in the information processing terminal 51. This makes it possible to install the printer driver efficiently.

### Fourth Variation

In a fourth variation, if the browser’s cookie policy prohibits cookies from being stored in the processing for saving the credentials executed in step S2307 of FIG. 23, the credentials are included in the installer package in an encrypted state. Doing so reduces the burden on the user for entering the credentials multiple times.

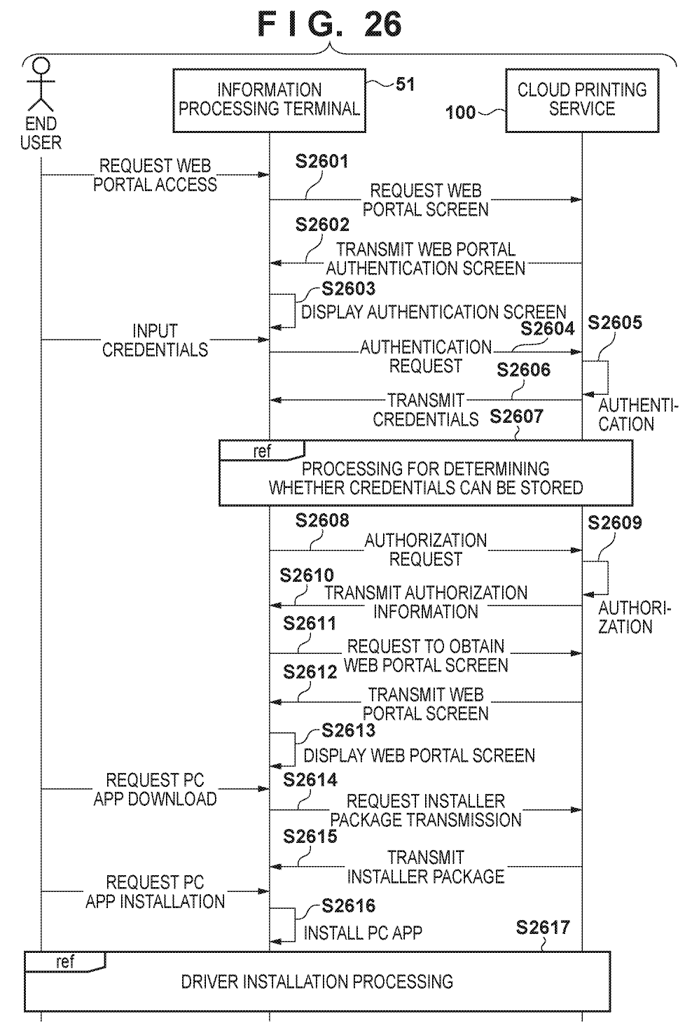

The flow of a sequence for displaying various web portal screens in the information processing terminal 51, and installing a PC application for using the cloud printing service 100 in the information processing terminal 51, will be described with reference to FIG. 26. This flow is executed instead of the flow illustrated in FIG. 23, described in the third variation. This flow is also a flow in which processing is added when the credentials are not saved in the cache of the browser in the flow illustrated in FIG. 23. Note that descriptions of parts where configurations and processing sequences are the same as in the third variation will be omitted here, and only the differences will be described.

Note that this sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120. Note that this sequence is executed when an end user of the cloud printing service 100 launches the web page display unit 520, such as a web browser of the information processing terminal 51.

Steps S2601 to S2606 are the same as steps S2301 to S2306, and will therefore not be described here. In step S2607, the web page display unit 520 determines whether the credentials received in step S2606 can be saved in the browser. More specifically, the web page display unit 520 determines, for example, whether the user has consented to a cookie policy. The web page display unit 520 also determines, for example, whether cookies are set to be saved according to the browser settings.

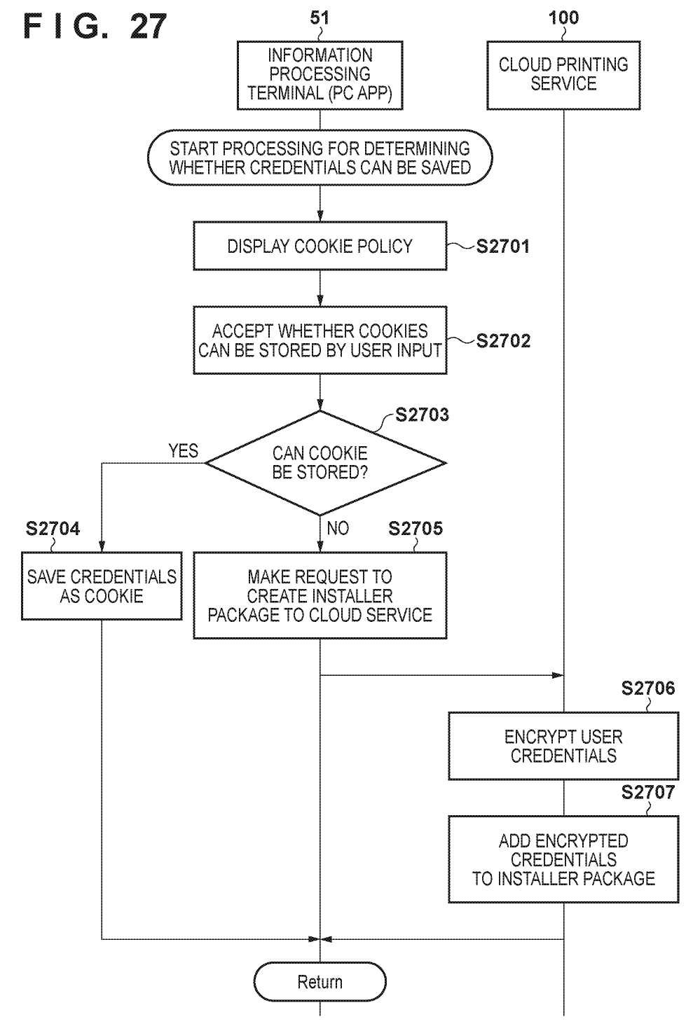

A flowchart illustrating the processing of step S2607 in detail will be described with reference to FIG. 27. This processing is realized by programs stored in the ROM 514 of the information processing terminal 51 being read out into the RAM 513 and executed by the CPU 512.

In step S2701, the web page display unit 520 displays a dialog requesting the user to consent to the storage of cookies. In step S2702, the web page display unit 520 accepts the user’s input as to whether cookies can be stored. In step S2703, the web page display unit 520 determines whether cookies can be stored. If the web page display unit 520 determines that cookies can be stored, the sequence moves to step S2704. In step S2704, the web page display unit 520 saves the credentials as a cookie in the browser in the same manner as in step S2307 in the third variation.

On the other hand, if, in step S2703, the web page display unit 520 determines that cookies cannot be stored, the sequence moves to step S2705. In step S2705, using the network communication unit 510, the web page display unit 520 transmits a request for creating an installer package to the cloud printing service 100. The web portal 421 of the cloud printing service 100 receives the request using the network I/F 170. In step S2706, the web portal 421 encrypts the credentials of the previously-authenticated user. In step S2707, the web portal 421 combines the credentials of the user encrypted in step S2706 with the installer package. The sequence then moves to step S2608 of FIG. 26.

The descriptions will now return to FIG. 26. The processing of steps S2608 to S2614 is the same as that of steps S2308 to S2314, and will therefore not be described. In step S2615, the web portal 421 of the cloud printing service 100 obtains the installer package of the PC application 530 held in cloud storage 423. The web portal 421 then transmits the installer package to the information processing terminal 51 using the network I/F 170. Then, the web page display unit 520 of the information processing terminal 51 receives the installer package.

The installer package is in the format of an executable file of the PC application 530, an executable file compressed in ZIP format, or the like, and is a format that can be installed by the end user using a function of the OS of the information processing terminal 51. In addition to the installer of the PC application 530, the installer package also includes the tenant information on the tenant to which the user who requested the obtainment of the installer package belongs. The tenant information is information capable of uniquely identifying a tenant, and is the tenant ID, for example. If the processing of step S2707 has been executed, the installer package further includes the credentials of the user.

In step S2616, the web page display unit 520 accepts an instruction from the end user, e.g., an instruction for executing the executable file. The web page display unit 520 then installs the PC application 530. If, at the time of the installation, the user credentials encrypted in step S2707 are included in the installer package, the PC application 530 stores the credentials in a storage medium such as the HDD 515. Tenant information and the like included in the installer package is also stored in the HDD 515 or the like. In step S2617, the PC application 530 performs processing for installing the driver to be used. This processing sequence will be described in detail later. The processing then ends.

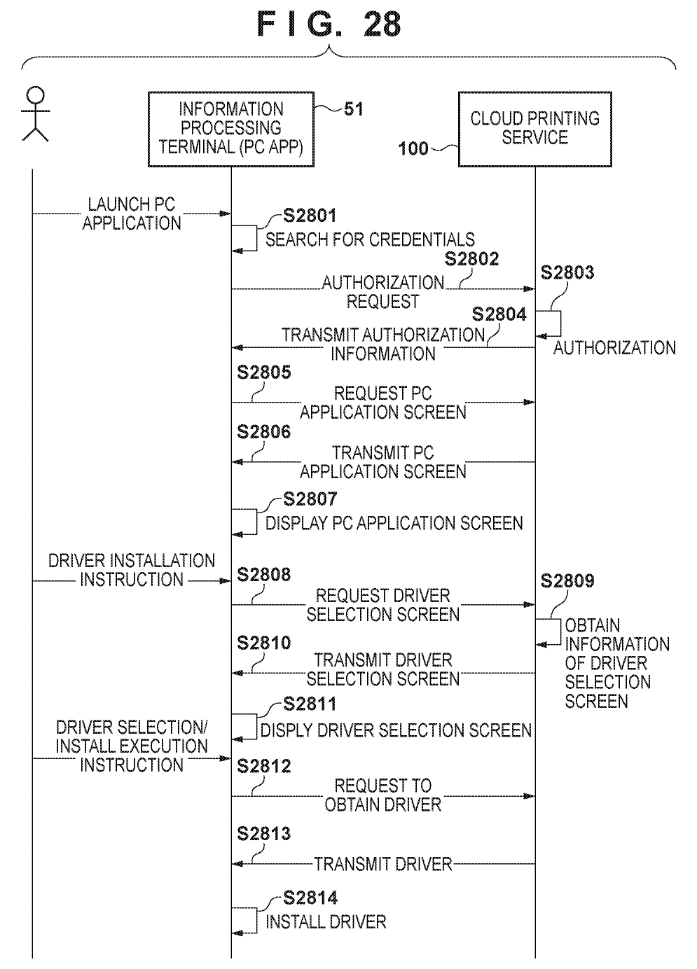

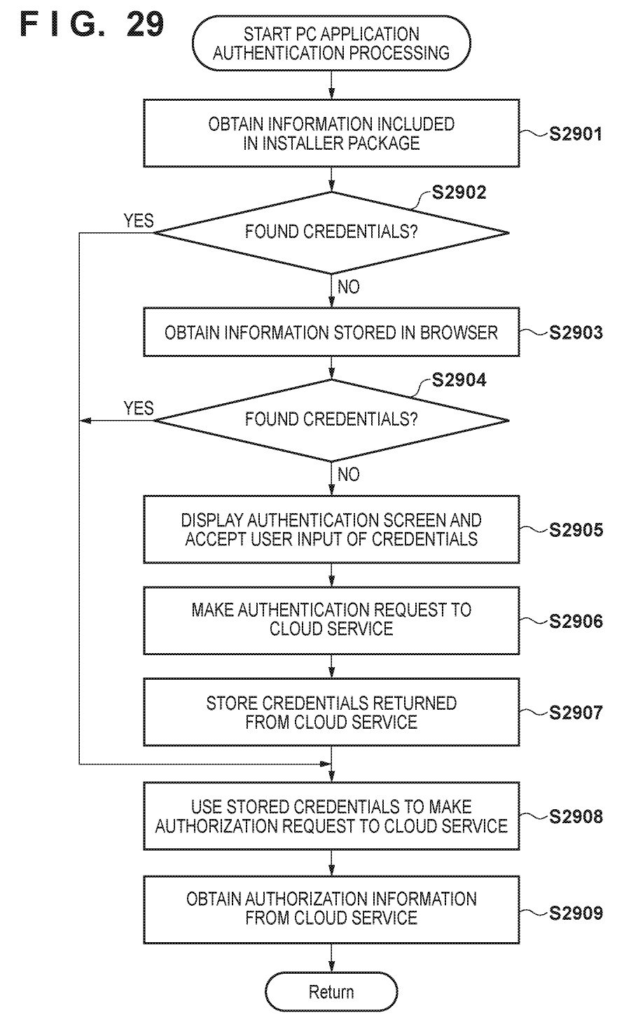

The processing of step S2617 will be described in detail with reference to FIG. 28. The processing is a sequence of processing performed up to the PC application 530 installed in the information processing terminal 51 obtaining a printer driver on the basis of a designation by the end user from the cloud printing service 100 and installing the printer driver. This sequence is executed instead of the sequence illustrated in FIG. 24 and performed in the third variation. This sequence is realized by the information processing terminal 51 and the cloud printing service 100 executing their respective processing while communicating over the network 10. The processing by the information processing terminal 51 is realized by programs stored in the ROM 514 being read out into the RAM 513 and executed by the CPU 512. Similarly, the processing by the cloud printing service 100 is realized by programs stored in the ROM 140 being read out into the RAM 130 and executed by the CPU 120.

In step S2801, the PC application 530 searches for credentials obtained from the browser or the installer package and stored in the HDD 515 or the like. In step S2802, the PC application 530 transmits the credentials and an authorization request to the cloud printing service 100 using the network communication unit 510. The web portal 421 of the cloud printing service 100 then receives the credentials and the authorization request. In step S2803, the web portal 421 transmits the credentials to authentication management 413. The authentication management 413 then executes the authorization processing. In step S2804, the authentication management 413 transmits the authorization information to the information processing terminal 51. The PC application 530 of the information processing terminal 51 then receives the authorization information.

The processing of steps S2801 to S2804, performed in the information processing terminal 51, will be described in detail with reference to FIG. 29. This processing obtains the information stored in the HDD 515 in step S2616, or the information stored in the browser in step S2704, at the time of the authentication processing by the PC application 530. If credentials have been successfully obtained, the authorization processing is executed using the credentials. However, if credentials have not been successfully obtained, the authentication and authorization processing are executed after accepting credentials entered by the user. Note that this processing is realized by programs stored in the ROM 514 of the information processing terminal 51 being read out into the RAM 513 and executed by the CPU 512.

In step S2901, the PC application 530 obtains the information included in the installer package and stored in the HDD 515 in step S2616. In step S2902, the PC application 530 determines whether credentials are present. If the PC application 530 determines that credentials are present, the sequences advances in the order of steps S2908 and S2909, after which the processing of step S2805 in the flowchart of FIG. 28 is executed. Note that steps S2908 and S2909 are the same as steps S2506 and S2507 of FIG. 25 in the third variation, and will therefore not be described.

However, if the PC application 530 determines that no credentials are present, the sequence moves to step S2903. Steps S2903 to S2909 are then executed, after which the processing of step S2805 in the flowchart illustrated in FIG. 28 is executed. Note that the processing of steps S2903 to S2909 is the same as steps S2501 to S2507 of FIG. 25 in the third variation, and will therefore not be described. The processing then ends.

The descriptions will now return to FIG. 28. Steps S2805 to S2814 are the same as steps S2402 to S2411 in FIG. 24, and will therefore not be described.

### Actions and Effects

According to the fourth variation, the following processing is executed during the processing for installing the driver performed by the PC application 530 in the information processing terminal 51. That is, if the browser’s cookie policy prohibits cookies from being stored (step S2303 in FIG. 23), the web portal 421 encrypts the credentials authenticated previously in the cloud printing service 100 and combines the encrypted credentials with the installer package. Doing so makes it possible to eliminate the need for the user to enter their credentials multiple times. This makes it possible to install the printer driver efficiently.

### Fifth Variation

In a fifth variation, the input of the tenant information when the user enters their credentials in the authentication processing executed by the PC application 530 in the information processing terminal 51 can be omitted.

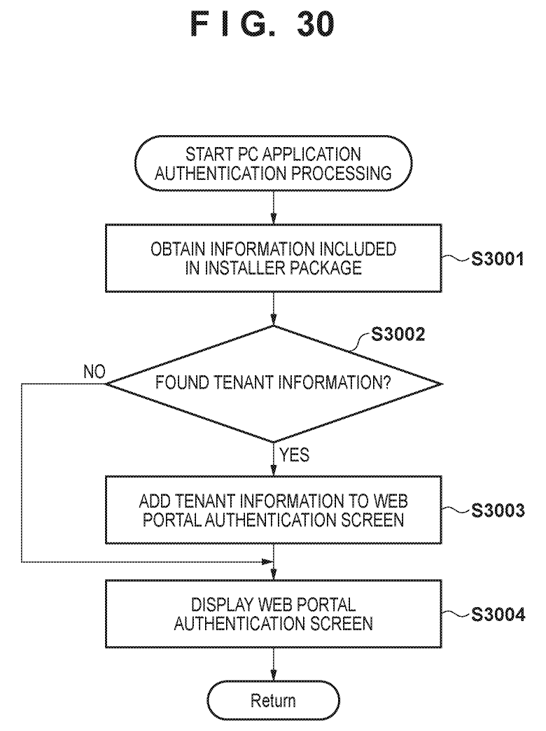

Processing for generating the authentication screen for logging into the web portal will be described with reference to FIG. 30. Note that this processing is realized by programs stored in the ROM 514 of the information processing terminal 51 being read out into the RAM 513 and executed by the CPU 512.

In step S3001, the PC application 530 obtains the information included in the installer package obtained in step S909 of FIG. 9. In step S3002, the PC application 530 determines whether tenant information is present. If the PC application determines that the tenant information is present, the sequence moves to step S3003; if not, the sequence moves to step S3004.

In step S3003, the PC application 530 adds the tenant information obtained in step S3001 to the authentication screen for logging into the web portal. In step S3004, the web page display unit 520 displays the web portal authentication screen to which the tenant information has been added. The web page display unit 520 then accepts the entry of a user ID and a password in the authentication screen. The sequence then moves to step S911 of FIG. 9, for example.

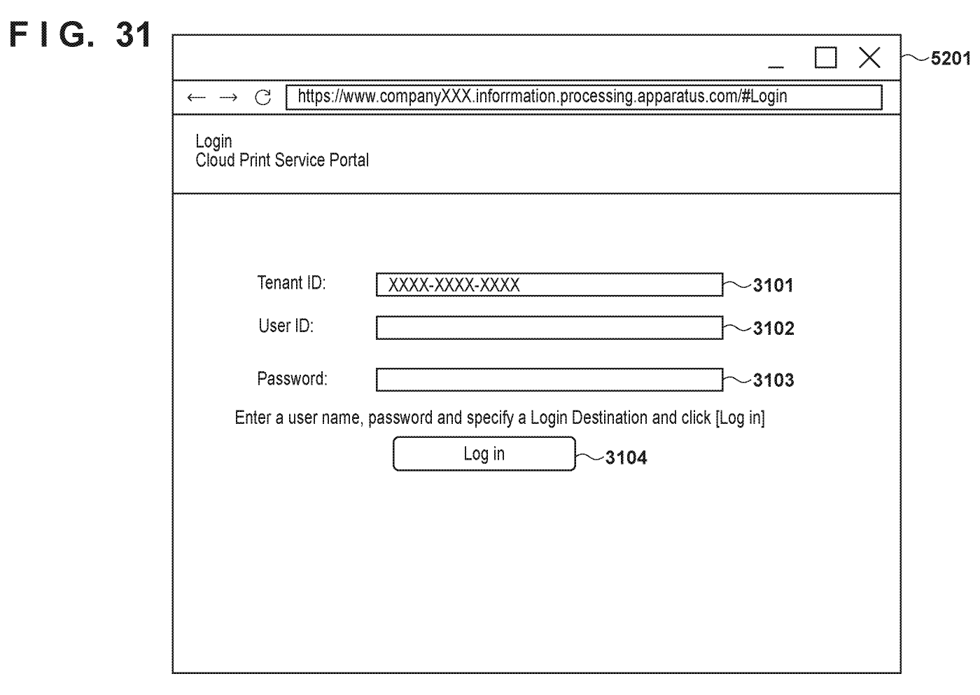

The authentication screen displayed by the web page display unit 520 in step S3004 will be described with reference to FIG. 31. If the tenant information is present in the installer package in step S3002, that tenant information is displayed in advance in an entry field 3101. Other entry fields 3102 and 3103, and a button 3104, are the same as those displayed in the web page 5201 illustrated in FIG. 10, and will therefore not be described.

### Actions and Effects

According to the fifth variation, tenant information included in the installer package obtained in step S909 of FIG. 9 is displayed in advance in the authentication screen during the authentication processing performed by the PC application 530 in the information processing terminal 51. This makes it possible to eliminate the need for the user to enter the tenant information. This in turn makes it possible to install the printer driver efficiently.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-008576, filed January 21, 2025, which is hereby incorporated by reference herein in its entirety.

What is claimed is:

1. An information processing apparatus capable of communicating with a cloud printing server that provides a cloud printing service, the information processing apparatus comprising:
one or more memory devices that store a set of instructions; and
one or more processors that execute the set of instructions to:
control communication with the cloud printing server and an application for using the cloud printing service,
wherein the one or more processors execute instructions in the one or more memory devices to:
receive an installer package of the application, which is transmitted from the cloud printing server;
control receiving of information about an image forming apparatus from the cloud printing server, the image forming apparatus being registered in a tenant to which a user belongs, being usable by the user, and being capable of communicating with the cloud printing server;
cause the application, which is installed using the installer package, to display a screen for selecting a driver corresponding to the image forming apparatus usable by the user, for which the information was received;
transmit an obtainment request for the driver selected in the screen to the cloud printing server; and
control receiving of, from the cloud printing server, the driver for which the obtainment request was made.

2. The information processing apparatus according to claim 1,
wherein the one or more processors further execute instructions in the one or more memory devices to:
cause the application to determine whether the user is an administrator; and
in a case where the application determines that the user is an administrator, control receiving of information about all image forming apparatuses registered in the tenant as the information about the image forming apparatus usable by the user.

3. The information processing apparatus according to claim 1,
wherein the one or more processors further execute instructions in the one or more memory devices to:
control receiving of information about a group to which the user belongs and information about an image forming apparatus usable by the group; and
cause the application to display, in a selectable manner in the screen, a driver of the image forming apparatus usable by the group, for which the information was received.

4. The information processing apparatus according to claim 1,
wherein the one or more processors further execute instructions in the one or more memory devices to:
cause the application to display, in the screen:
a first object for selecting a driver usable in common for all image forming apparatuses registered in the tenant;
a second object for selecting a driver usable in common for only some of the image forming apparatuses registered in the tenant; and
a third object for selecting a model-specific driver for each of the image forming apparatuses registered in the tenant.

5. The information processing apparatus according to claim 1,
wherein the one or more processors further execute instructions in the one or more memory devices to:
cause the application to display a model name and an installation location for each image forming apparatus in the screen in a list format.

6. An information processing system comprising:
the information processing apparatus according to claim 1 and the cloud printing server,
the cloud printing server comprising:
one or more memory devices that store a set of instructions; and
one or more processors that execute the set of instructions to:
store information about the image forming apparatus usable by the user; and
perform communication with the information processing apparatus,
wherein the one or more processors in the cloud printing server execute instructions in the one or more memory devices to:
receive, from the information processing apparatus, a request for the information about the image forming apparatus usable by the user; and
transmit, to the information processing apparatus, the stored information about the image forming apparatus usable by the user.

7. The information processing system according to claim 6,
wherein the one or more processors in the cloud printing server further execute instructions in the one or more memory devices to:
store the driver of the image forming apparatus;
receive, from the information processing apparatus, an obtainment request for the driver selected in the screen; and
transmit, to the information processing apparatus, the driver for which the obtainment request was received.

8. The information processing system according to claim 7,
wherein the one or more processors in the cloud printing server execute instructions in the one or more memory devices to:
store the information about the image forming apparatus usable by the user in association with identification information of the user.

9. A control method for an information processing apparatus capable of communicating with a cloud printing server that provides a cloud printing service, the control method comprising:
controlling communication with the cloud printing server and an application for using the cloud printing service,
wherein an installer package of the application, which is transmitted from the cloud printing server, is received,
control is performed regarding receiving of information about an image forming apparatus from the cloud printing server, the image forming apparatus being registered in a tenant to which a user belongs, being usable by the user, and being capable of communicating with the cloud printing server,
the application, which is installed using the installer package, is caused to display a screen for selecting a driver corresponding to the image forming apparatus usable by the user, for which the information was received,
an obtainment request for the driver selected in the screen is transmitted to the cloud printing server, and
control is performed regarding receiving of, from the cloud printing server, the driver for which the obtainment request was made.

10. A non-transitory computer-readable storage medium storing a computer program for causing a computer to execute each of steps of a control method for an information processing apparatus capable of communicating with a cloud printing server that provides a cloud printing service, the control method comprising:
controlling communication with the cloud printing server and an application for using the cloud printing service,
wherein an installer package of the application, which is transmitted from the cloud printing server, is received,
control is performed regarding receiving of information about an image forming apparatus from the cloud printing server, the image forming apparatus being registered in a tenant to which a user belongs, being usable by the user, and being capable of communicating with the cloud printing server,
the application, which is installed using the installer package, is caused to display a screen for selecting a driver corresponding to the image forming apparatus usable by the user, for which the information was received,
an obtainment request for the driver selected in the screen is transmitted to the cloud printing server, and
control is performed regarding receiving of, from the cloud printing server, the driver for which the obtainment request was made.
